(19) United States
(12) Patent Application Publication
(10) Pub. No.: US 2025/0264821 A1
(43) Pub. Date: Aug. 21, 2025

(54) METHOD FOR PRODUCING TONER

(71) Applicant: CANON KABUSHIKI KAISHA, Tokyo (JP)

(72) Inventors: KENTA KAMIKURA, Kanagawa (JP); SATOSHI ARIMURA, Kanagawa (JP); TAKUHO SATO, Shizuoka (JP); MOTOYA FUKUSHIMA, Shizuoka (JP)

(21) Appl. No.: 19/053,253

(22) Filed: Feb. 13, 2025

(30) Foreign Application Priority Data
Feb. 16, 2024 (JP) 2024-021721

(51) Int. Cl. G03G 9/08; G03G 9/087

(52) U.S. Cl. CPC G03G 9/0815; G03G 9/0806; G03G 9/0819; G03G 9/0827; G03G 9/08711; G03G 9/08755

(57) ABSTRACT

The disclosure provides a method for producing a toner including a washing step of washing resin particles with a washing liquid, wherein the resin particles have a functional group —(COO⁻)ₙAⁿ⁺ (wherein Aⁿ⁺ denotes a metal ion or an ammonium ion, and n denotes an integer of 1 or more and 3 or less) on a surface thereof, the washing liquid contains fine bubbles, the fine bubbles in the washing liquid have a number-average particle diameter of 1.0×10¹ nm or more and 1.0×10⁵ nm or less, and the fine bubbles in the washing liquid have a zeta potential of −60 mV or more and 0 mV or less.

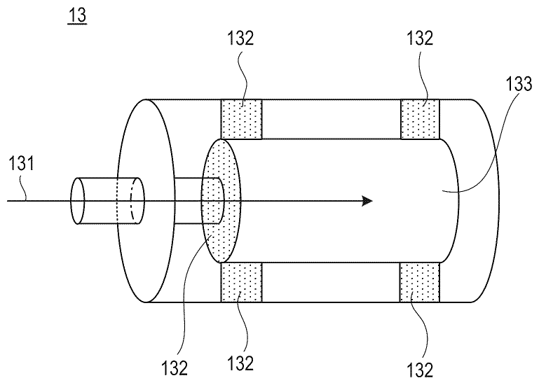

### BACKGROUND

### Field of the Disclosure

The present disclosure relates to a method for producing a toner for use in a recording method utilizing electrophotography, an electrostatic recording method, or a toner jet recording method.

### Description of the Related Art

In recent years, operating environments of printers and copying machines using electrophotography have been diversified, and a toner is required to exhibit stable performance even under various operating environments. To form a stable image in electrophotography, the chargeability of toner should be precisely controlled.

To control the charge amount of toner, a toner with a functional group, such as a carboxy group or a sulfonic acid group, on the toner surface has been studied as a negatively chargeable toner, and a toner with a functional group, such as a quaternary ammonium base, on the toner surface has been studied as a positively chargeable toner. These functional groups have high charge transfer performance by friction, and the toner can have improved chargeability.

Thus, the chargeability of toner is greatly affected by a material constituting the toner. Furthermore, the chargeability of toner is affected by the ambient humidity, and the charge amount tends to decrease particularly in a high-humidity environment. This is probably because water molecules adsorbing to the toner surface decrease the resistivity of the toner surface and make it easier for electric charges to leak.

To suppress the adsorption of water molecules to the toner surface, it is necessary to control the amount of hydrophilic substance present on the toner surface. In particular, in a toner produced in an aqueous medium, a salt formed by bonding between a cation, such as a metal ion, in the aqueous medium and an acid group, such as a carboxy group, present on the toner surface tends to remain on the toner surface. Salts are generally hydrophilic substances, and there is a problem that a salt remaining on the toner surface decreases the charge amount.

Japanese Patent Laid-Open No. 2010-113112 discloses a method for producing a toner including a step of subjecting a toner-particle dispersion liquid to a reslurry washing treatment with an alkaline solution of pH 8 to 12 and a step of subjecting the dispersion liquid to a reslurry washing treatment with an acidic solution of pH 2 to 6. Japanese Patent Laid-Open No. 2012-198518 discloses a washing method of using an ionic liquid as a washing aid to wash toner particles.

In the method according to Japanese Patent Laid-Open No. 2010-113112, however, it has been confirmed that counter ions of the alkali and acid used remain in the toner and reduce the chargeability in a high-humidity environment.

In the method according to Japanese Patent Laid-Open No. 2012-198518, a production reaction substance containing a surfactant and ions absorbed on the surface and inside of the toner is removed using an ionic liquid, but in this method, the amount of metal on the surface cannot be sufficiently decreased, and it has been confirmed that a trace amount of residual ionic liquid used reduces the chargeability in a high-humidity environment as in Japanese Patent Laid-Open No. 2010-113112.

As described above, in the conventional studies, salt present on the toner surface cannot be sufficiently decreased and causes a problem in the chargeability in a high-humidity environment.

### SUMMARY

The present disclosure solves the above problems and provides a method for producing a toner with high chargeability even in a high-humidity environment by sufficiently reducing the amount of salt on a toner surface, even in the presence of a carboxy group.

A method for producing a toner according to the present disclosure includes a washing step of washing resin particles with a washing liquid,
wherein the resin particles have the following functional group on a surface thereof, —(COO⁻)ₙAⁿ⁺
wherein Aⁿ⁺ denotes a metal ion or an ammonium ion, and n denotes an integer of 1 or more and 3 or less,
the washing liquid contains fine bubbles,
the fine bubbles in the washing liquid have a number-average particle diameter of 1.0×10¹ nm or more and 1.0×10¹ nm or less, and
the fine bubbles in the washing liquid have a zeta potential of −60 mV or more and 0 mV or less.

Further features of the present disclosure will become apparent from the following Detailed Description and Examples with reference to the attached drawing.

### BRIEF DESCRIPTION OF THE DRAWING

Figure is a schematic view of a Faraday cage.

### DETAILED DESCRIPTION

Unless otherwise specified, the numerical range “ . . . or more and . . . or less” or “ . . . to . . . ”, as used herein, refers to the numerical range including the lower limit and the upper limit.

### Features of Present Disclosure

A method for producing a toner according to the present disclosure includes a washing step of washing resin particles with a washing liquid,
wherein the resin particles have a functional group —(COO⁻)ₙAⁿ⁺ (wherein Aⁿ⁺ denotes a metal ion or an ammonium ion, and n denotes an integer of 1 or more and 3 or less) on a surface thereof,
the washing liquid contains fine bubbles,
the fine bubbles in the washing liquid have a number-average particle diameter of 1.0×10¹ nm or more and 1.0×10¹ nm or less, and
the fine bubbles in the washing liquid have a zeta potential of −60 mV or more and 0 mV or less.

In a method for producing a toner according to the present disclosure, although it is not clear why the amount of salt present on the toner surface can be sufficiently reduced and consequently a toner with high chargeability even in a high-humidity environment can be produced, the present inventors suggest the reason as described below.

The resin particles in the present disclosure are a precursor of a toner and are subjected to a washing step, followed, if necessary, by a drying step, a classification step, an external addition step, and the like to produce the toner. Thus, the surface of the resin particles at least partly forms the surface of the final toner. The surface state of the resin particles therefore has a great influence on the charged state of the toner. As described above, since the amount of salt on the toner surface affects the chargeability, reducing the amount of salt on the surface of the resin particles improves the chargeability of the toner.

The resin particles in the present disclosure have, on the surface thereof, a salt in which a hydrogen ion (H⁺) of a carboxy group (—COO⁻H⁺) is substituted with Aⁿ⁺ (hereinafter referred to as a cation). To remove the salt, it is necessary to substitute the cation with a hydrogen ion again to return to the original carboxy group. In typical washing with water, washing proceeds by substituting cations with hydrogen ions contained in water. In a neutral aqueous medium, however, the hydrogen ion concentration [H⁺] is as low as 1.0×10⁻⁷ (mol/L), and in particular, when the functional group —(COO⁻)ₙAⁿ⁺ decreases, the equilibrium shifts to the salt side, making washing difficult. Thus, to achieve at least a certain level of washing effect, it is necessary to more positively promote the dissociation between a cation and a carboxy group.

The present inventors have focused on an aqueous medium containing fine bubbles. It is known that in an aqueous medium containing fine bubbles with a diameter of less than 100 μm, hydroxide ions are aligned around the fine bubbles, and the fine bubbles have a negative zeta potential. Since the hydrogen ion concentration is equal to the hydroxide ion concentration in a neutral aqueous medium, it is assumed that the fine bubbles have a structure with a high hydroxide ion concentration in the vicinity thereof and a high hydrogen ion concentration in the periphery thereof.

In the present disclosure, the washing effect is obtained by utilizing the interaction between this structure and the positive charge of a cation. First, a cation is released from a carboxy group by the interaction between the negative charge of a fine bubble and the cation.

The released cation then binds to a hydroxide ion near the fine bubble and is removed out of the system. At the same time, a hydrogen ion present around the fine bubble is supplied to the carboxy group from which the cation has been released to complete the washing process. Other ions do not intervene in the washing process and do not affect the chargeability of the toner. This makes it possible to produce a toner with high chargeability.

The present disclosure is described in detail below.

### [Fine Bubbles]

The washing liquid in the present disclosure contains fine bubbles. The configurations of the fine bubbles and the washing liquid in the present disclosure are described in detail below.

### <Physical Properties of Fine Bubbles>

The fine bubbles in the present disclosure have a number-average particle diameter of 1.0×10¹ nm or more and 1.0×10⁵ nm or less. Fine bubbles with a number-average particle diameter in this range can easily approach the vicinity of resin particles and produce a high washing effect. The fine bubbles in the present disclosure may have a number-average particle diameter of 1.0×10¹ nm or more and 1.0×10 nm or less. Fine bubbles with a number-average particle diameter in this range can be stably present in an aqueous medium for extended periods.

Thus, a high washing effect can be consistently produced. The fine bubbles in the present disclosure may have a number-average particle diameter of 5.0×10¹ nm or more and 5.0×10² nm or less.

A method for controlling the number-average particle diameter of fine bubbles may include a change in the production conditions of the fine bubbles, a membrane separation method of separating generated fine bubbles using a membrane, or the like. The membrane separation method is a method of dropping a washing liquid containing fine bubbles onto a plurality of filters having pores with a desired diameter to separate and classify the fine bubbles with a desired diameter.

The fine bubbles in the present disclosure have a zeta potential of −60 mV or more and 0 mV or less. In the fine bubbles with a zeta potential in this range, hydroxide ions are aligned on the surface of the fine bubbles and generate a concentration gradient of hydrogen ions and hydroxide ions in the washing liquid. This can produce the effect of removing cations, as described above. The fine bubbles in the present disclosure may have a zeta potential of −10 mV or less. The fine bubbles with a zeta potential in this range increase the concentration gradient of hydrogen ions and hydroxide ions in the washing liquid and further improve the washing effect.

The fine bubbles in the present disclosure may have a zeta potential of −30 mV or more. The fine bubbles with a zeta potential in this range can suppress the repulsion between the fine bubbles and resin particles while maintaining a sufficient cation removal effect and further improve the washing effect. Furthermore, since the fine bubbles are easily adsorbed on the surface of the resin particles, even when the washing step is followed by a drying step including heating, the resin particles are less likely to be subjected to a thermal history due to the heat-insulating effect of the fine bubbles present on the surface of the resin particles serving as a toner precursor.

Thus, it is possible to suppress deterioration of transferability and developability and occurrence of soiling of a member in a developing process due to exudation of a release agent, a plasticizer, or the like to be contained in the toner to the toner surface.

A method for controlling the zeta potential of fine bubbles may include a change in the type of gas constituting the fine bubbles, a change in the pH of the washing liquid, or the like.

The fine bubbles in the present disclosure may have a number concentration of 1.0×10⁴ particles/mL or more, or 1.0×10⁶ particles/mL or more. When the fine bubbles in the present disclosure have a number concentration in this range, a sufficient washing effect can be obtained with a small amount of washing liquid. This improves the washing efficiency.

A method for controlling the number concentration of fine bubbles may include concentration by the membrane separation method, a change in production conditions of the fine bubbles, dilution by addition of an aqueous medium, or the like.

### <Methods for Measuring Physical Properties of Fine Bubbles>

Physical properties of the fine bubbles are measured as described below.

### [Number-Average Particle Diameter and Number Concentration of Fine Bubbles]

The number-average particle diameter and the number concentration of fine bubbles are measured as described below using a particle size analyzer ViewSizer3000 (manufactured by Horiba, Ltd.) utilizing a particle tracking method.

An aqueous medium containing fine bubbles is prepared as a sample. 2 ml of a measurement sample is injected into a quartz cell (High Precision Cell: manufactured by Hellma Analytic, 10×10 mm) equipped with a stirrer bar and a dedicated jig, both attached to the analyzer, and the cell is then placed in a cell holder of the analyzer. Nano tracking analysis is started from an application attached to the analyzer to perform the measurement with the following settings.
Target temperature: 22
#of videos: 30
Frame per second: 30
Exposure: 18
Gain: 24
Stirring time: 5
Video length: 300
Laser power B: 70
   G: 12
   R: 8

After completion of the measurement, the numerical value (nm) of “Average size” displayed on the measurement result screen is defined as the number-average particle diameter of the fine bubbles, and the numerical value (particles/mL) of “Particle Concentration” is defined as the number concentration of the fine bubbles.

In the measurement, it is confirmed that the fine bubbles in an image displayed on the display has a clear outline when stirring is turned on in the “Streaming” mode and that there is little overlap between the fine bubbles in the image when “stirring” is off. When the outline is unclear, the focus is adjusted using the “Focus” function. When the overlap between the fine bubbles is significant, the sample is diluted. When the sample is diluted, the number concentration of the fine bubbles is determined by multiplying the value of the obtained “Particle Concentration” by the dilution ratio.

### [Zeta Potential of Fine Bubbles]

The zeta potential of the fine bubbles is measured as described below using a zeta potential analyzer ZetaSizer Nano ZSP (manufactured by Malvern) utilizing an electrophoretic light scattering method.

An aqueous medium containing fine bubbles is prepared as a sample. A disposable capillary cell for measuring zeta potential (DTS1060 manufactured by Malvern) is filled with a measurement sample and is placed in a cell holder of the analyzer. Zeta potential measurement is selected from an application attached to the analyzer to perform the measurement under the following conditions.
F(ka)selection Model: Smoluchowski
Dispersant: Water
Temperature: 25° C.
Result Calculation: General Purpose

After completion of the measurement, the numerical value (mV) of “Zeta Potential” in the displayed report screen of the measurement results is defined as the zeta potential of the fine bubbles.

### <Method for Producing Fine Bubbles>

A method for producing fine bubbles according to the present disclosure may be any known method. Specific examples thereof include a method based on the principle of gas phase dispersion by liquid flow shearing exemplified by a swirling liquid flow type, a static mixer type, a mechanical shearing type, a micropore type, or a fluid vibration type; a method based on the principle of a change in gas solubility in liquid exemplified by a pressure dissolution type or a heating precipitation type; a method based on the principle of cavitation exemplified by an ejector type, a Venturi type, or an ultrasonic type; a method based on the principle of a phase change of a dispersed phase exemplified by a mixed vapor condensation type; and a method based on the principle of a chemical change of a liquid phase exemplified by an electrolysis type.

In particular, a method based on the principle of cavitation can be used because fine bubbles can be efficiently formed. Although a Venturi type fine bubble production method is described in detail below as an example of the method based on the principle of cavitation, the present disclosure is not limited thereto.

In the Venturi type fine bubble production method, a liquid containing a dissolved target gas is supplied to a Venturi tube with a constricted portion. The pressure of the liquid passing through the constricted portion is decreased below the saturated vapor pressure of the gas according to Bernoulli's theorem due to an increase in flow velocity, resulting in the formation of bubbles in the liquid due to a cavitation phenomenon. After passing through the constricted portion, the liquid is pressurized again as the flow velocity decreases, and the formed bubbles collapse into fine bubbles due to the pressure.

### [Washing Liquid]

The washing liquid in the present disclosure may be any washing liquid containing the fine bubbles. In particular, the washing liquid can be a washing liquid produced by the method for producing fine bubbles described above using, as a raw material, an aqueous medium containing 95% by mass or more of water as a main component. Furthermore, due to a low ion content except for hydrogen ions and hydroxide ions, the washing liquid can be a washing liquid produced by the method for producing fine bubbles using deionized water or RO water produced by a reverse osmosis method as a raw material.

The washing liquid may have a temperature in the range of 30° C. to 50° C., or 35° C. to 45° C. A washing liquid with a temperature in this range has improved cation removal efficiency. In typical washing, the washing efficiency increases with the temperature of the washing liquid. This is because the solubility or dispersibility of an object to be washed increases with the temperature. On the other hand, in a washing liquid containing fine bubbles, the washing efficiency depends on the interaction between an object to be washed and the fine bubbles. The fine bubble concentration correlates with the solubility of the gas in the liquid, and the solubility of the gas is generally higher at a lower temperature. Thus, it is presumed that the temperature of a washing liquid suitable for a washing method in the present disclosure has a peak, and the washing efficiency is highest at a temperature at which both the solubility or dispersibility of an object to be washed and the solubility of the gas are enhanced.

Next, resin particles used in the present disclosure are described in detail below.

### [Resin Particles]

The resin particles in the present disclosure are a precursor of a toner.

The resin particles in the present disclosure have a functional group —(COO⁻)ₙAⁿ⁺ (wherein Aⁿ⁺ denotes a metal ion or an ammonium ion, and n denotes an integer of 1 or more and 3 or less) on a surface thereof. The —(COO⁻)ₙAⁿ⁺ present on the surface of the resin particles in the present disclosure can be a salt formed by a carboxy group of a resin with the carboxy group present on the surface of the resin particles and a metal ion or an ammonium ion, or a salt formed by a carboxy group of a resin with the carboxy group present on the surface of the resin particles and a metal ion.

<Resin with Carboxy Group>

The resin with a carboxy group in the present disclosure can be used as a binder resin in a toner produced using resin particles.

The resin with a carboxy group in the present disclosure may be any known resin with a carboxy group. In particular, because the acid value of the surface of the resin particles is easily controlled to 0.02 mgKOH/g or more and 1.00 mgKOH/g or less, a resin with a carboxy group with an acid value of 1.00 mgKOH/g or more and 50.00 mgKOH/g or less may be used, and a resin with a carboxy group with an acid value of 2.50 mgKOH/g or more and 30.00 mgKOH/g or less may be used.

More specifically, the resin may be a polyester resin, a vinyl resin, a polyurethane resin, a polyamide resin, or the like, each having a carboxy group. In particular, a polyester resin or a vinyl resin can be used from the perspective that the hydrophilicity of the resin is easily adjusted to an appropriate range and the adsorptivity between the fine bubbles and the resin particles is easily enhanced.

### <Polyester Resin>

A polyester resin can be synthesized by combining suitable compounds selected from a polycarboxylic acid, a polyol, a hydroxycarboxylic acid, and the like and by using a known method, such as a transesterification method or a polycondensation method.

The polycarboxylic acid is a compound with two or more carboxy groups per molecule. In particular, a dicarboxylic acid is a compound with two carboxy groups per molecule and is often used. A polycarboxylic acid described below may be in the form of a derivative, such as an anhydride, a halide, an ester, or an amide, if necessary.

The dicarboxylic acid is, for example, an aromatic dicarboxylic acid exemplified by phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, naphthalene-1,4-dicarboxylic acid, naphthalene-1,5-dicarboxylic acid, naphthalene-2,6-dicarboxylic acid, anthracenedicarboxylic acid, or the like; a linear aliphatic saturated dicarboxylic acid exemplified by oxalic acid, malonic acid, succinic acid, glutaric acid, adipic acid, pimelic acid, suberic acid, sebacic acid, azelaic acid, nonanedicarboxylic acid, decanedicarboxylic acid, undecanedicarboxylic acid, dodecanedicarboxylic acid, or the like; a linear aliphatic unsaturated dicarboxylic acid exemplified by fumaric acid, maleic acid, glutaconic acid, or the like; a branched aliphatic saturated dicarboxylic acid exemplified by β-methyladipic acid, n-dodecylsuccinic acid, or the like; a branched aliphatic unsaturated dicarboxylic acid exemplified by citraconic acid, itaconic acid, n-dodecenylsuccinic acid, or the like; a dicarboxylic acid containing a heteroatom exemplified by diglycolic acid; an alicyclic saturated dicarboxylic acid exemplified by 1,4-cyclohexanedicarboxylic acid, 1,3-cyclohexanedicarboxylic acid, 1,2-cyclohexanedicarboxylic acid, 2,3-norbornanedicarboxylic acid, or the like; an alicyclic unsaturated dicarboxylic acid exemplified by cis-4-cyclohexene-1,2-dicarboxylic acid or cis-5-norbornene-endo-2,3-dicarboxylic acid; or the like. In particular, an aromatic dicarboxylic acid or a linear aliphatic saturated dicarboxylic acid can be used, or an aromatic dicarboxylic acid can be used. These may be used alone or in combination.

A polycarboxylic acid other than the dicarboxylic acid is, for example, a tricarboxylic acid exemplified by trimellitic acid, trimesic acid, naphthalenetricarboxylic acid, pyrenetricarboxylic acid, or the like; or a tetracarboxylic acid exemplified by pyromellitic acid, naphthalenetetracarboxylic acid, pyrenetetracarboxylic acid, or the like. These may be used alone or in combination. For the purpose of adjusting the resin acid value, a trivalent or higher polycarboxylic acid can be used.

The polyol is a compound with two or more hydroxy groups per molecule. In particular, a diol is a compound with two hydroxy groups per molecule and is often used.

Specific examples thereof include a bisphenol exemplified by bisphenol A, bisphenol F, or bisphenol S, or an alkylene oxide (ethylene oxide, propylene oxide, butylene oxide, or the like) adduct thereof; a linear aliphatic saturated diol exemplified by ethylene glycol, 1,3-propylene glycol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, or the like; a branched aliphatic saturated diol exemplified by 1,2-propylene glycol, neopentyl glycol, or the like; a linear diol containing a heteroatom exemplified by diethylene glycol, triethylene glycol, dipropylene glycol, poly(ethylene glycol), poly(propylene glycol), poly(tetramethylene ether) glycol, or the like; an alicyclic saturated diol exemplified by 1,4-cyclohexanediol, 1,4-cyclohexanedimethanol, hydrogenated bisphenol A, or the like; a linear aliphatic unsaturated diol exemplified by 1,4-butenediol or the like; and a cyclic diol containing a heteroatom exemplified by isosorbide or the like. In particular, a linear aliphatic saturated diol, an alkylene oxide adduct of a bisphenol, and a cyclic diol containing a heteroatom can be used. These may be used alone or in combination.

A trihydric or higher polyhydric polyol is, for example, a triol exemplified by glycerin, trimethylolethane, trimethylolpropane, or the like; a tetraol exemplified by pentaerythritol or the like; or a hexaol exemplified by dipentaerythritol, sorbitol, or the like. These may be used alone or in combination.

### <Vinyl Resin>

The vinyl resin may be a polymer or copolymer of a vinyl monomer, such as a styrene monomer exemplified by styrene, α-methylstyrene, divinylbenzene, or the like; an unsaturated carboxylate exemplified by methyl acrylate, butyl acrylate, methyl methacrylate, 2-hydroxyethyl methacrylate, t-butyl methacrylate, 2-ethylhexyl methacrylate, lauryl acrylate, lauryl methacrylate, stearyl acrylate, stearyl methacrylate, 1,6-hexanediol diacrylate, or the like; an unsaturated carboxylic acid exemplified by acrylic acid, methacrylic acid, or the like; an unsaturated dicarboxylic acid exemplified by maleic acid or the like; an unsaturated dicarboxylic anhydride exemplified by maleic anhydride; a nitrile vinyl monomer exemplified by acrylonitrile or the like; a vinyl monomer containing a halogen exemplified by vinyl chloride or the like; or a nitro vinyl monomer exemplified by nitrostyrene or the like.

For the purpose of adjusting the resin acid value, a copolymer of a styrene monomer or a vinyl monomer containing an unsaturated carboxylate or an unsaturated carboxylic acid can be used. Furthermore, for the purpose of adjusting the molecular weight, among the vinyl monomers, a monomer with a plurality of vinyl groups, such as divinylbenzene or 1,6-hexanediol diacrylate, can be used as a crosslinking agent.

The resin with a carboxy group may have a glass transition temperature in the range of 30° C. to 110° C., or 50° C. to 90° C. The resin with a carboxy group may have a peak molecular weight (Mp) in the range of 3000 to 50,000, or 5000 to 20,000.

### <Metal Ion and Ammonium Ion Aⁿ⁺ (Cation)>

In the present disclosure, the cation that forms a salt with a carboxy group may be a known metal ion or an ammonium ion. In particular, a metal ion can be used. Specific examples thereof include a monovalent metal ion exemplified by Li⁺, Na⁺, K⁺, Ag⁺, or the like, a divalent metal ion exemplified by Mg²⁺, Ca²⁺, Zn²⁺, Fe²⁺, or the like, and a trivalent metal ion exemplified by Al³⁺, Fe³⁺, or the like. In particular, a divalent or polyvalent metal ion is difficult to remove by a known washing method, and the removal effect by fine bubbles is easily obtained.

Such a cation present in an ionic state in an aqueous medium can form an ionic bond with a carboxy group present on the surface of the resin particles and can be fixed to the surface of the resin particles.

### <Relationship Between Mass P of Resin Particles and Mass W of Washing Liquid>

The ratio P/W of the mass P of the resin particles in the washing step to the mass W of the washing liquid used in the washing step may be 0.1 or more and 1.0 or less. The value of P/W denotes the efficiency of washing, and a higher value indicates a lower load on the environment and more efficient washing.

### <Relationship Between Mass M of Cation and Mass W of Washing Liquid>

The ratio M/W of the mass M of a metal ion or an ammonium ion in the resin particles in the washing step to the mass W of the washing liquid used in the washing step may be 5.0×10⁻⁶ or less. Satisfying the above relationship can suppress the occurrence of clogging due to reprecipitation of a cation as a salt in a filter paper or a filter cloth. Thus, even when the washing step is continuously performed, the filtration efficiency does not decrease, and the washing step can be efficiently performed.

<Relationship Between Mass M1 of Cation before Washing Step and Mass M2 of Cation after Washing Step>

The reduction ratio (M1−M2)/M1 of the mass of a metal ion or an ammonium ion may be 0.50 or more, wherein M1 denotes the mass of the metal ion or the ammonium ion in the resin particles before the washing step, and M2 denotes the mass of the metal ion or the ammonium ion in the resin particles after the washing step. The relationship of the reduction ratio indicates that the amount of salt present on the toner surface can be sufficiently reduced to improve the chargeability in a high-humidity environment.

Next, other materials that can be used for the resin particles are described in detail below.

### <Another Resin>

The resin particles in the present disclosure may contain another resin in addition to the resin with a carboxy group. The other resin can be used as a binder resin in a toner produced using resin particles.

The other resin may be any known resin. Specific examples thereof include a polyester resin, a vinyl resin, a polyurethane resin, and a polyamide resin. In particular, a vinyl resin can be used.

When used as a binder resin, the other resin may have a glass transition temperature in the range of 30° C. to 90° C., or 40° C. to 80° C. The peak molecular weight (Mp) may range from 3000 to 50,000, or 5000 to 40,000.

### <Release Agent and Plasticizer>

The resin particles in the present disclosure can contain a release agent and/or a plasticizer. The materials listed below can be used as either a release agent or a plasticizer depending on the relationship with the resin used at the same time. In the selection, an appropriate one can be selected in consideration of the compatibility with the resin or the like.

More specifically, a material with low compatibility with the resin is separated from the resin in a fixing process, exhibits releasability from a fixing member, and can be used as a release agent for enabling good separation from the fixing member. By contrast, a material with high compatibility with the resin is compatibly mixed with the resin in the fixing process, reduces the viscosity, and can be used as a plasticizer for enabling fixing at a lower temperature.

A known wax, silicone oil, or the like can be used as a release agent and/or a plasticizer without particular limitation. In particular, a wax can be used.

Specific examples thereof include a petroleum hydrocarbon wax, such as paraffin wax, microcrystalline wax, or petrolatum, or a derivative thereof, montan wax or a derivative thereof, and a hydrocarbon wax produced by the Fischer-Tropsch process or a derivative thereof;
an ester wax exemplified by
a monofunctional ester wax exemplified by an ester of a monohydric alcohol and an aliphatic carboxylic acid, such as behenyl behenate, stearyl stearate, behenyl stearate, or palmityl palmitate, or an ester of a monocarboxylic acid and an aliphatic alcohol;
a bifunctional ester wax exemplified by an ester of a dihydric alcohol and an aliphatic carboxylic acid, such as ethylene glycol distearate, dibehenyl sebacate, or hexanediol dibehenate, or an ester of a dicarboxylic acid and an aliphatic alcohol;
a trifunctional ester wax exemplified by an ester of a trihydric alcohol and an aliphatic carboxylic acid, such as glycerin tribehenate, or an ester of a tricarboxylic acid and an aliphatic alcohol;
a tetrafunctional ester wax exemplified by an ester of a tetrahydric alcohol and an aliphatic carboxylic acid, such as pentaerythritol tetrastearate or pentaerythritol tetrapalmitate, or an ester of a tetracarboxylic acid and an aliphatic alcohol;
a hexafunctional ester wax exemplified by an ester of a hexahydric alcohol and an aliphatic carboxylic acid, such as dipentaerythritol hexastearate or dipentaerythritol hexapalmitate, or an ester of a hexacarboxylic acid and an aliphatic alcohol;
an ester of a polyhydric alcohol and an aliphatic carboxylic acid, such as polyglycerol behenate, or an ester of polycarboxylic acid and an aliphatic alcohol; or
a natural ester wax, such as carnauba wax or rice wax, and
a polyolefin hydrocarbon wax, such as polyethylene or polypropylene, or a derivative thereof, and a natural wax, such as carnauba wax or candelilla wax, or a derivative thereof. The derivative includes an oxide, a block copolymer with a vinyl monomer, or a graft modified material.

Also included are an alcohol, such as a higher aliphatic alcohol; a fatty acid, such as stearic acid or palmitic acid, or an acid amide, ester, or ketone thereof; a hydrogenated castor oil or a derivative thereof, a plant wax, and an animal wax. These may be used alone or in combination.

In particular, a hydrocarbon wax and an ester wax can be used. In general, a hydrocarbon wax tends to have low compatibility with a resin and can be used as a release agent. On the other hand, an ester wax tends to have high compatibility with a resin and can be used as a plasticizer. The ester wax can be a monofunctional ester wax or a bifunctional ester wax. In particular, at least one selected from the group consisting of a compound represented by the following formula (4), a compound represented by the following formula (5), and a compound represented by the following formula (6) can be used.

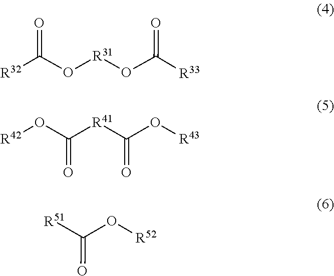

(In the formulae (4), (5), and (6), R³¹ and R⁴¹ each independently denote an alkylene group with 2 or more and 8 or less carbon atoms, and R³², R³³, R⁴², R⁴³, R⁵¹, and R⁵² each independently denote a linear alkyl group with 14 or more and 24 or less (or 16 or more and 24 or less) carbon atoms.)

In the analysis of toner particles by time-of-flight secondary ion mass spectrometry, the abundance ratio Cw (%) of an ester wax may be 10% or less, or 0% or more and 5% or less, or 0% or more and 3% or less, or 0% or more and 1% or less, or 0%. Cw in this range indicates that the amount of the ester wax on the toner surface is small. Cw in the above range results in a decrease in the adhesion strength of the toner to the drum and improved transferability.

The release agent and/or plasticizer content may be 1.0 part by mass or more and 50.0 parts by mass or less per 100.0 parts by mass of the resin with a carboxy group and the other resin in total.

The release agent and/or plasticizer may have a melting point of 60° C. or more and 120° C. or less, or 60° C. or more and 100° C. or less, or 60° C. or more and 80° C. or less.

### <Colorant>

The resin particles in the present disclosure may contain a colorant. The colorant may be, but is not limited to, a known pigment or dye of black, yellow, magenta, cyan, or another color, a magnetic material, or the like.

The black colorant may be a black pigment, such as carbon black.

The yellow colorant may be a yellow pigment or a yellow dye, such as a monoazo compound; a disazo compound; a condensed azo compound; an isoindolinone compound; a benzimidazolone compound; an anthraquinone compound; an azo metal complex; a methine compound; or an allylamide compound. More specifically, C.I. Pigment Yellow 74, 93, 95, 109, 111, 128, 155, 174, 180, or 185, C.I. Solvent Yellow 162, or the like may be mentioned.

The magenta colorant may be a magenta pigment or a magenta dye, such as a monoazo compound; a condensed azo compound; a diketopyrrolopyrrole compound; an anthraquinone compound; a quinacridone compound; a basic dye lake compound; a naphthol compound; a benzimidazolone compound; a thioindigo compound; or a perylene compound. More specifically, C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 238, 254, or 269, C.I. Pigment Violet 19, or the like may be mentioned.

The cyan colorant may be a cyan pigment or a cyan dye, such as a copper phthalocyanine compound or a derivative thereof, an anthraquinone compound, or a basic dye lake compound.

More specifically, C.I. Pigment Blue 1, 7, 15, 15:1, 15:2, 15:3, 15:4, 60, 62, or 66, or the like may be mentioned.

The colorant content may be 1.0 part by mass or more and 20.0 parts by mass or less per 100.0 parts by mass of the resin with a carboxy group and the other resin in total.

The toner may be a magnetic toner containing a magnetic material. In this case, the magnetic material can also function as a colorant.

The magnetic material may be an iron oxide exemplified by magnetite, hematite, or ferrite; a metal exemplified by iron, cobalt, or nickel, an alloy of this metal and a metal, such as aluminum, cobalt, copper, lead, magnesium, tin, zinc, antimony, beryllium, bismuth, cadmium, calcium, manganese, selenium, titanium, tungsten, or vanadium, a mixture thereof, or the like.

When a magnetic material is used as a colorant, the magnetic material content may be 20.0 parts by mass or more and 120.0 parts by mass or less per 100.0 parts by mass of the resin with a carboxy group and the other resin in total.

### <Charge Control Agent>

The resin particles in the present disclosure may contain a charge control agent. The charge control agent may be, but is not limited to, a known charge control agent.

More specifically, as a negative charge control agent, the following may be mentioned: a metal compound of an aromatic carboxylic acid, such as salicylic acid, an alkyl salicylic acid, a dialkyl salicylic acid, naphthoic acid, or a dicarboxylic acid, or a polymer or copolymer with a metal compound of the aromatic carboxylic acid; a polymer or copolymer with a sulfonic acid group, a sulfonic acid salt group, or a sulfonic ester group; a metal salt or a metal complex of an azo dye or an azo pigment; a boron compound, a silicon compound, calixarene, or the like.

On the other hand, as a positive charge control agent, the following may be mentioned: a quaternary ammonium salt, a polymer compound with a quaternary ammonium salt in a side chain; a guanidine compound; a nigrosine compound; an imidazole compound; or the like. A polymer or copolymer with a sulfonic acid salt group or a sulfonic ester group may be a homopolymer of a vinyl monomer with a sulfonic acid group, such as styrenesulfonic acid, 2-acrylamido-2-methylpropanesulfonic acid, 2-methacrylamido-2-methylpropanesulfonic acid, vinylsulfonic acid, or methacryl sulfonic acid, a copolymer of the vinyl monomer described in the section of the resin with a carboxy group and the vinyl monomer with a sulfonic acid group, or the like.

The charge control agent content may be 0.01 parts by mass or more and 5.0 parts by mass or less per 100.0 parts by mass of the resin with a carboxy group and the other resin in total.

### <Physical Properties of Resin Particles>

The surface of the resin particles may have an acid value of 0.02 mgKOH/g or more and 1.00 mgKOH/g or less. When the surface of the resin particles has an acid value in this range, the toner is likely to have a charge amount in a suitable range. The surface of the resin particles may have an acid value of 0.05 mgKOH/g or more and 0.50 mgKOH/g or less, or 0.05 mgKOH/g or more and 0.30 mgKOH/g or less.

The resin particles may have an average circularity of 0.960 or more. The surface of the resin particles with an average circularity in this range is likely to be uniformly washed. This also reduces the adhesiveness to the drum and improves the transferability. The resin particles may have an average circularity of 0.980 or more.

### <Method for Producing Resin Particles>

The resin particles used in the washing step in the present disclosure are not particularly limited and can be produced by a wet process exemplified by a suspension polymerization method, an emulsion aggregation method, a dissolution suspension method, or the like, a dry process exemplified by a pulverization method, or the like. In particular, the resin particles can be produced by a wet process because the resin with a carboxy group for improving chargeability is easily disposed on the surface of the resin particles, and the release agent and the plasticizer are rarely exposed, so that a toner with high chargeability and endurance is easily produced. In particular, a suspension polymerization method or a emulsion aggregation method can be used.

Although a process of producing resin particles by a suspension polymerization method and raw materials in the production method are described in detail below, the present disclosure is not limited to these examples.

### [Production Process]

### Dispersion Step

A dispersion step is a step of dispersing the colorant in the presence of a polymerizable monomer to produce a colorant dispersion liquid. A dispersing apparatus in the dispersion step can be a known media type dispersing apparatus or non-media type dispersing apparatus.

Furthermore, a resin with a carboxy group, a charge control agent, and another raw material may be added in the dispersion step.

### Mixing Step

A mixing step is a step of mixing a polymerizable monomer, a colorant, a release agent, a resin with a carboxy group, and another raw material to produce a polymerizable monomer composition. The colorant dispersion liquid produced by the dispersion step may be used as the polymerizable monomer and the colorant. In addition to the colorant dispersion liquid, a resin with a carboxy group, a polymerizable monomer, and a colorant may be further added. In the mixing step, a polymerization initiator and a charge control agent may be further added.

### Granulation Step

A granulation step is a step of forming particles of a polymerizable monomer composition in an aqueous medium to produce a suspension. The method of particle formation is not particularly limited and, for example, a strong stirring apparatus, such as an (in-line type) emulsification dispersing apparatus (manufactured by Pacific Machinery & Engineering Co., Ltd., trade name “Milder”) or a high-speed emulsification dispersing apparatus (manufactured by Primix Corporation, trade name “Homomixer”) can be used. The aqueous medium can contain a dispersion stabilizer. In the granulation step, a polymerization initiator may be further added.

### Polymerization Step

A polymerization step is a step of polymerizing a polymerizable monomer contained in particles of a polymerizable monomer composition in a suspension to produce a resin. The resin produced by the polymerization step may be used as a resin with a carboxy group.

### Distillation Step

A distillation step is a step of removing an unreacted polymerizable monomer. A known method, such as atmospheric distillation, distillation under reduced pressure, or steam distillation, can be used as a distillation method.

### Dispersant Removal Step

A dispersant removal step is a step of removing a dispersion stabilizer. For example, when an inorganic dispersant is used, a treatment can be performed using a known acid, base, or the like under conditions in which the inorganic dispersant is dissolved to remove a dispersion stabilizer.

### Filtration Step

A filtration step is a step of filtering resin particles dispersed in an aqueous medium for solid-liquid separation. The washing step may be performed after the filtration step or may be performed before the filtration step and can be performed on a cake to be washed formed by the filtration step.

When resin particles are obtained in the form of a cake containing water after the filtration step, a drying step described later can be performed. When the drying step described later is performed, to efficiently perform the drying step, a crushing step can be performed after the filtration step to crush the cake into several millimeters to several centimeters square.

### [Raw Materials]

### <Polymerizable Monomer>

Any known polymerizable monomer can be used as a polymerizable monomer used in a suspension polymerization method. In particular, the vinyl monomers listed in the section of the vinyl resin in the description of the resin with a carboxy group can be suitably used.

### <Polymerization Initiator>

Any known polymerization initiator can be used as a polymerization initiator used in a suspension polymerization method. Specific examples thereof include a peroxide polymerization initiator exemplified by hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethyl benzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, pertriphenylacetic acid-tert-hydroperoxide, performic acid-tert-butyl, peracetic acid-tert-butyl, perbenzoic acid-tert-butyl, perphenylacetic acid-tert-butyl, permethoxyacetic acid-tert-butyl, per-N-(3-toluyl)palmitic acid-tert-butylbenzoyl peroxide, t-butylperoxy-2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, lauroyl peroxide, or the like; and an azo or diazo polymerization initiator exemplified by 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobisisobutyronitrile, or the like. In particular, a peroxide polymerization initiator can be used.

The polymerization initiator may be used in an amount of 1.0 part by mass or more and 20.0 parts by mass or less per 100.0 parts by mass of the polymerizable monomer(s).

### <Dispersion Stabilizer>

Any known dispersion stabilizer can be used as a dispersion stabilizer used in a suspension polymerization method. Specific examples thereof include a poorly water-soluble phosphate exemplified by tricalcium phosphate, hydroxyapatite, magnesium phosphate, zinc phosphate, aluminum phosphate, or the like; another inorganic dispersion stabilizer exemplified by calcium carbonate, magnesium carbonate, calcium hydroxide, magnesium hydroxide, aluminum hydroxide, calcium metasilicate, calcium sulfate, barium sulfate, bentonite, silica, alumina, or the like; an organic dispersion stabilizer exemplified by poly(vinyl alcohol), gelatin, methyl cellulose, methylhydroxypropyl cellulose, ethyl cellulose, a sodium salt of carboxymethyl cellulose, starch, or the like; an anionic surfactant exemplified by an alkyl sulfate ester salt, an alkylbenzene sulfonate, a fatty acid salt, or the like; a nonionic surfactant exemplified by a polyoxyethylene alkyl ether, a polyoxypropylene alkyl ether, or the like; and a cationic surfactant exemplified by an alkylamine salt, a quaternary ammonium salt, or the like.

In particular, a poorly water-soluble phosphate has a large dispersion stabilizing effect and is easily removed. In particular, a phosphate containing calcium, such as tricalcium phosphate or hydroxyapatite, can be used because the zeta potential can be easily controlled and the affinity for fine bubbles can be easily controlled.

The dispersion stabilizer may be used in an amount of 0.5 parts by mass or more and 5.0 parts by mass or less per 100.0 parts by mass of the polymerizable monomer(s).

Resin particles produced by these steps are subjected to the washing step of the present disclosure.

### [Method for Producing Toner]

A method for producing a toner according to the present disclosure includes a washing step of washing resin particles with a washing liquid. A method for producing a toner according to the present disclosure is described in detail below.

### <Washing Step>

The washing step in the present disclosure may be any known washing step. Specific examples thereof include a filtration washing step of washing resin particles by passing a washing liquid through a cake to be washed formed of the resin particles, a step of dispersing and washing resin particles in a washing liquid, and the like. In particular, in the filtration washing step, washing can be performed uniformly and efficiently with a small amount of washing liquid. When a washing liquid is passed through a cake to be washed in the filtration washing step, the washing efficiency can be further enhanced by pressurizing the upper portion of the cake to be washed or reducing the pressure of the lower portion of the cake to be washed. Furthermore, a continuous treatment is possible in a continuous filtration washing step of continuously performing washing while transferring a cake to be washed.

A filtration apparatus for use in the continuous filtration washing step may be a drum filter (manufactured by Mitsubishi Kakoki Kaisha, Ltd.), a blowback filter (manufactured by Mitsubishi Kakoki Kaisha, Ltd.), an Eagle filter (manufactured by Sumitomo Heavy Industries Environment Co., Ltd.), a vacuum horizontal belt filter (manufactured by Hitachi Zosen Corporation), a horizontal belt filter (manufactured by Tsukishima Kikai Co., Ltd.), an OS filter (manufactured by Japan Chemical Engineering & Machinery Co., Ltd.), or the like.

<Each Step after Washing Step>

After the washing step, a toner can be produced by the following steps.

### Drying Step

A drying step is a step of removing water contained in the washed cake formed in the filtration step. In the drying step in the present disclosure, a known drying method can be used without limitation. Specific examples thereof include vacuum drying, fluidized bed drying, and airflow drying. In particular, a loop airflow dryer can uniformly apply heat using a drying gas and can satisfactorily separate dried toner particles from undried toner particles. The loop airflow dryer is, for example, a flash jet dryer (manufactured by Seishin Enterprise Co., Ltd.), a jet turbo dryer (manufactured by Hiraiwa Iron Works Co., Ltd.), or the like.

### Classification Step

The classification step is a step of removing particles with a small particle diameter and/or a large particle diameter from resin particles to produce toner particles. The classification step may be performed depending on the particle size and the particle size distribution of the resin particles.

### External Addition Step

The external addition step is a step of mixing the toner particles with an external additive to attach the external additive to the surface of the toner particles and impart characteristics, such as flowability and chargeability, to produce a toner. The external addition step may be performed depending on the required toner characteristics. When the external addition step is not performed, the toner particles produced in the drying step or the classification step can also be directly used as a toner.

A mixer for externally adding the external additive to the toner particles can be, but is not limited to, a known dry or wet mixer. Examples thereof include an FM mixer (manufactured by Nippon Coke & Engineering Co., Ltd.), a super mixer (manufactured by Kawata Mfg. Co., Ltd.), Nobilta (manufactured by Hosokawa Micron Corporation), and a hybridizer (manufactured by Nara Machinery). A toner can be prepared by adjusting the rotation speed of the external addition apparatus, the treatment time, and the temperature and amount of water in the jacket to control the coating state of the external additive.

A sifter used for sieving coarse particles after external addition may be Ultrasonic (manufactured by Koeisangyo Co., Ltd.), Resonasieve and Gyro-Sifter (Tokuju Corporation), Vibrasonic system (manufactured by Dalton Corporation), Soniclean (manufactured by Sintokogio, Ltd.), Turbo Screener (manufactured by Turbo Kogyo Co., Ltd.), Micro sifter (manufactured by Makino Mfg. Co., Ltd.), or the like.

Any known external additive can be used as an external additive used in the external addition step.

Specific examples thereof include raw fine silica particles exemplified by wet silica or dry silica; surface-treated fine silica particles produced by subjecting raw fine silica particles to surface treatment with a treatment agent, such as a silane coupling agent, a titanate coupling agent, silicone oil, or a fatty acid; fine metal oxide particles exemplified by fine titanium oxide particles, fine aluminum oxide particles, fine zinc oxide particles, or cerium oxide; surface-treated fine metal oxide particles produced by subjecting fine metal oxide particles to surface treatment with a treatment agent, such as a silane coupling agent, a titanate coupling agent, silicone oil, or a fatty acid; fine composite oxide particles exemplified by fine strontium titanate particles; surface-treated composite oxide fine particles produced by subjecting composite oxide fine particles to surface treatment with a treatment agent, such as a silane coupling agent, a titanate coupling agent, silicone oil, or a fatty acid; a fatty acid metal salt exemplified by zinc stearate, calcium stearate, or the like; a clay mineral exemplified by hydrotalcite or the like; and fine resin particles, such as fine vinylidene fluoride particles, fine polytetrafluoroethylene particles, or the like.

The external additive content is 0.1 parts by mass or more and 10.0 parts by mass or less per 100.0 parts by mass of the toner particles.

### [Methods for Measuring Physical Properties]

A method for measuring physical properties of resin particles, toner, and each material is described below.

### <Isolation of Resin Particles>

The pH of a resin particle dispersion liquid before the washing step is adjusted to 2.0 by adding 10% HCl. The solid component is then filtered off and is washed three times with deionized water in the same amount as the resin particle dispersion liquid. The solid component is then dried in a vacuum dryer at 40° C. for 24 hours to remove water and produce resin particles.

<Detection of —(COO⁻)ₙAⁿ⁺>

—(COO⁻)ₙAⁿ⁺ on the surface of the resin particles is detected by the following method using X-ray photoelectron spectroscopy (XPS) and time-of-flight secondary ion mass spectrometry (TOF-SIMS).

The presence of a metal element or an ammonium ion on the surface of the resin particles is confirmed by measuring the resin particles under the following conditions.
Measuring apparatus: X-ray photoelectron spectrometer: Quantum 2000 (manufactured by ULVAC-PHI, Inc.)
X-ray source: Monochromatic Al Kα
Xray Setting: 100 pmp (25 W (15 KV))
Photoelectron take-off angle: 45 degrees
Neutralization condition: Combination of flood gun and ion gun
Area of analysis: 300×200 μm
Pass energy: 58.70 eV
Step size: 0.125 eV
Analysis software: Multipak (PHI)

Next, as an example, a method for determining the quantitative value of a metal element Ca through analysis is described below. First, a peak derived from a C—C bond of a carbon is orbital is corrected to 285 eV. The formation of a salt with a carboxy group is then confirmed from the peak shift at the position corresponding to each orbital of Ca (2s orbital: 440 eV, 2p1/2 orbital: 351 eV, 2p3/2 orbital: 347 eV, or the like).

For the ammonium ion, the following analysis by TOF-SIMS is performed.

A resin particle sample is analyzed using TOF-SIMS (TRIFTIV: manufactured by ULVAC-PHI, Inc.) under the following conditions.
Primary ion species: gold ion (Au⁺)
Primary ion current value: 2 pA
Analysis area: 300×300 μm²
Number of pixels: 256×256 pixels
Analysis time: 3 min
Repetition frequency: 8.2 kHz
Charge neutralization: ON
Secondary ion polarity: positive
Secondary ion mass range: m/z 0.5 to 1850
Specimen substrate: indium

Detection of a peak derived from an ammonium ion (m/z: 18) in the analysis under the above conditions indicates the presence of the ammonium ion on the surface of the resin particles.

### <Measurement of Acid Value of Resin Particle Surface>

The acid value of the surface of resin particles is measured by the following neutralization titration method.

10.0 g of resin particles are dispersed in 100 mL of a 5.0% by weight aqueous solution of a nonionic surfactant Contaminon N (manufactured by Fujifilm Wako Pure Chemical Corporation).

The resulting dispersion liquid is titrated with 0.1 mol/L ethanolic KOH. The acid value (mgKOH/g) of the surface of the resin particles is calculated from the amount of the ethanolic KOH used, with the endpoint defined as a pH of 9.0.

### <Measurement of Resin Acid Value>

The acid value is the number of milligrams of potassium hydroxide required to neutralize an acid contained in 1 g of a specimen. The acid value of a binder resin is measured according to JIS K 0070-1992. More specifically, the measurement is performed according to the following procedure.

### (1) Preparation of Reagent

1.0 g of phenolphthalein is dissolved in 90 ml of ethyl alcohol (95% by volume) and is diluted to 100 ml with deionized water to prepare a phenolphthalein solution. 7 g of special grade potassium hydroxide is dissolved in 5 ml of water and is diluted to 1 liter with ethyl alcohol (95% by volume). The solution is placed in an alkali-resistant container so as not to be exposed to carbon dioxide gas or the like, is allowed to stand for 3 days, and is then filtered to prepare a potassium hydroxide solution. The potassium hydroxide solution is stored in an alkali-resistant container. The factor of the potassium hydroxide solution is determined by adding several drops of the phenolphthalein solution to 25 ml of 0.1 mol/l hydrochloric acid in a conical flask, titrating with the potassium hydroxide solution, and determining the amount of the potassium hydroxide solution required for neutralization. The 0.1 mol/l hydrochloric acid is prepared according to JIS K 8001-1998.

### (2) Operation

### (A) Main Test

2.0 g of a specimen of ground amorphous resin and crystalline resin is accurately weighed in a 200-ml conical flask and is dissolved in 100 ml of a toluene/ethanol (2:1) mixed solution over 5 hours. Several drops of the phenolphthalein solution are then added thereto as an indicator, and titration is performed using the potassium hydroxide solution. The endpoint of the titration is when the light red color of the indicator has continued for approximately 30 seconds.

### (B) Blank Test

Titration is performed in the same manner as the above operation except that the specimen is not used (that is, only the toluene/ethanol (2:1) mixed solution is used).

(3) The Results are Substituted into the Following Formula to Calculate the Acid Value.

$$A = [ ( C - B ) \times f \times 5.61 ] / S$$

A denotes the acid value (mgKOH/g), B denotes the addition amount (ml) of the potassium hydroxide solution in the blank test, C denotes the addition amount (ml) of the potassium hydroxide solution in the main test, f denotes the factor of the potassium hydroxide solution, and S denotes the specimen (g).

### <Mass M of Metal Ion or Ammonium Ion>

A wavelength-dispersive X-ray fluorescence spectrometer “Axios” (manufactured by PANalytical) and the accompanying dedicated software “SuperQ ver. 4.0F” (manufactured by PANalytical) for measurement condition setting and measurement data analysis are used to measure the mass of the metal ion or the ammonium ion in the resin particles by the following method.

A case where Ca is used as the metal is described as an example, but the same applies to other metals.

Rh is used as an anode of an X-ray tube, the measurement atmosphere is vacuum, the measurement diameter (collimator mask diameter) is 27 mm, and the measurement time is 10 seconds.

A light element is detected with a proportional counter (PC), and a heavy element is detected with a scintillation counter (SC).

4 g of resin particles are put into a special-purpose aluminum ring for pressing, are flattened, and are pressed at 20 MPa for 60 seconds using a tablet molding machine “BRE-32” (manufactured by Maekawa Testing Machine Mfg. Co., Ltd.) to form a pellet with a thickness of 2 mm and a diameter of 39 mm as a measurement sample.

A fine calcium chloride (CaCl₂) powder is added to polystyrene particles (Techpolymer SBX-8: manufactured by Sekisui Plastics Co., Ltd.) so as to be 0.01% by mass of the total amount of the resin particles and is sufficiently mixed using a coffee mill.

In the same manner, the fine calcium chloride powder is mixed with the polystyrene particles so as to be 0.05% by mass, 0.1% by mass, 0.5% by mass, 1.0% by mass, 5.0% by mass, 10.0% by mass, and 20.0% by mass and are used as specimens for a calibration curve.

For each specimen, a pellet of a specimen for a calibration curve is prepared as described above using a tablet molding machine, and the counting rate (unit: cps) of a Si-Kα ray observed at a diffraction angle (2θ) of 109.08 degrees when pentaerythritol (PET) is used for an analyzing crystal is measured.

The accelerating voltage and the current value of an X-ray generator are 24 kV and 100 mA, respectively.

A linear calibration curve is obtained by plotting the X-ray counting rate on the vertical axis and the amount of SiO2 added in each specimen for a calibration curve on the horizontal axis.

Next, the resin particles to be analyzed are formed into a pellet as described above using a tablet molding machine, and the counting rate of the Si-Kα ray is measured. The calcium element content (mol) of the toner is then determined from the calibration curve. The content is converted into a mass, which is defined as the mass M of the metal ion or the ammonium ion.

### <Method for Measuring Average Circularity>

The average circularity of resin particles is measured and analyzed with a flow particle image analyzer “FPIA-3000” (manufactured by Sysmex Corporation) under the following conditions.

The specific measurement method is described below. First, a glass container is charged with 20 ml of deionized water from which solid impurities and the like have been removed in advance. To the aqueous electrolyte is added 0.2 ml of a dispersant “Contaminon N” (a 10% by mass aqueous neutral detergent for cleaning precision measuring instruments composed of a nonionic surfactant, an anionic surfactant, and an organic builder, pH 7, manufactured by Wako Pure Chemical Industries, Ltd.) diluted 3-fold by mass with deionized water. Furthermore, 0.02 g of a measurement specimen is added thereto and is dispersed for 2 minutes using an ultrasonic disperser to prepare a dispersion liquid for measurement. The dispersion liquid is appropriately cooled to a temperature of 10° C. or more and 40° C. or less. The ultrasonic disperser is a table-top ultrasonic cleaner/disperser with an oscillation frequency of 50 kHz and an electrical output of 150 W (for example, “VS-150” (manufactured by Velvo-Clear)), and approximately 2 ml of Contaminon N is added to a predetermined amount of deionized water in a water tank.

The flow particle image analyzer equipped with an objective lens “UPlanApo” (magnification: 10, numerical aperture: 0.40) is used for the measurement, and the sheath liquid is a particle sheath “PSE-900A” (manufactured by SYSMEX Corporation). The dispersion liquid prepared by following the procedure described above is introduced into the flow particle image analyzer, and 3000 toner particles are measured in an HPF measurement mode and a total count mode. The binarization threshold in particle analysis is set at 85%, the particle diameter to be analyzed is limited to a circle-equivalent diameter of 1.985 μm or more and less than 39.69 μm, and the average circularity of the toner particles is determined.

Before measurement, automatic focus adjustment is performed using standard latex particles (for example, “RESEARCH AND TEST PARTICLES Latex Microsphere Suspensions 5200A” manufactured by Duke Scientific diluted with deionized water).

### <Identification of Wax in Toner>

(1) Method for Separating Wax from Toner

First, the melting point of wax in toner is measured with a thermal analyzer (DSC Q2000 manufactured by TA Instruments Japan). 3.0 mg of toner is put into a specimen vessel of an aluminum pan (KITNO. 0219-0041), and the specimen vessel is placed on a holder unit and is set in an electric furnace. The melting point of wax in the toner specimen is calculated by measuring a DSC curve with a differential scanning calorimeter (DSC) while heating from 30° C. to 200° C. at a heating rate of 10° C./min in a nitrogen atmosphere.

Resin particles are then dispersed in ethanol, which is a poor solvent for the toner, and are heated to a temperature exceeding the melting point of the wax. If necessary, pressure may be applied. By this operation, the wax with a temperature exceeding the melting point is melted and extracted in ethanol. The wax can be separated from the toner by solid-liquid separation during heating and, if pressurized, under maintained pressure. The extract is then dried and solidified to obtain the wax.

### (2) Identification of Wax by Pyrolysis GCMS

Specific conditions for identifying a wax by pyrolysis GCMS are described below.
Mass spectrometer: Thermo Fisher Scientific ISQ
GC apparatus: Thermo Fisher Scientific Focus GC
Ion source temperature: 250° C.
Ionization method: EI
Mass range: 50-1000 m/z
Column: HP-5MS [30 m]
Pyrolysis apparatus: JPS-700 manufactured by Japan Analytical Industry Co., Ltd.

A small amount of wax separated by the extraction operation and 1 μL of tetramethylammonium hydroxide (TMAH) are added to Pyrofoil at 590° C. The prepared sample is subjected to pyrolysis GCMS measurement under the above conditions to obtain a peak derived from the wax. When the wax is an ester compound, a peak is obtained for each of an alcohol component and a carboxylic acid component. The alcohol component and the carboxylic acid component are detected as methylated products by the action of the methylating agent TMAH. The molecular weight can also be determined by analyzing the obtained peaks and identifying the structure of the wax. For a hydrocarbon wax or the like with a molecular weight distribution, the most frequently detected component is selected for the molecular weight of the wax.

### <Method for Measuring Melting Point>

The melting point of a release agent or a plasticizer is measured under the following conditions using a differential scanning calorimeter (DSC) Q2000 (manufactured by TA Instruments).
Heating rate: 10° C./min
Measurement start temperature: 20° C.
Measurement end temperature: 180° C.

The melting points of indium and zinc are used for the temperature correction of a detecting unit of the apparatus, and the heat of fusion of indium is used for calorimetric correction.

More specifically, 5 mg of a specimen is precisely weighed, is placed in an aluminum pan, and is measured once. An empty aluminum pan is used as a reference. The peak temperature of the maximum endothermic peak is taken as the melting point.

### <Measurement of CW of Toner Particles by Time-of-Flight Secondary Ion Mass Spectrometry>

For the measurement of the amount of ion (peak intensity) using TOF-SIMS, TRIFT-IV manufactured by ULVAC-PHI, Inc. is used.

The analytical conditions are as follows:
Sample preparation: adhere toner particles to an indium sheet
Sample pretreatment: none
Primary ion: Au ion
Accelerating voltage: 30 kV
Charge neutralization mode: On
Measurement mode: positive
Raster: 300 μm
Measurement time: 60 s

A peak specific to each material was selected from a spectrum obtained by measuring a preparation of an ester wax, and the peak intensity of the surface of toner particles was compared with the peak intensity of the preparation to calculate the abundance ratio of the ester wax on the surface of the toner particles.

### <Method for Measuring Glass Transition Temperature (Tg) of Toner>

The glass transition temperature (Tg) of a binder resin is measured with a differential scanning calorimeter “Q1000” (manufactured by TA Instruments)” in accordance with ASTM D3418-82. The melting points of indium and zinc are used for the temperature correction of a detecting unit of the apparatus, and the heat of fusion of indium is used for calorimetric correction. More specifically, 5 mg of toner is precisely weighed, is placed in an aluminum pan, and is measured in the measurement range of 30° C. to 200° C. at a heating rate of 1° C./min using an empty aluminum pan as a reference. In this temperature rise process, the specific heat changes in the temperature range of 40° C. to 100° C. The glass transition temperature (Tg) of the toner is an intersection point between a differential heat curve and a line passing through an intermediate point of the baseline before and after the change in specific heat.

### <Method for Measuring Weight-Average Particle Diameter>

The weight-average particle diameter (D4) of resin particles, toner particles, or toner (hereinafter also referred to as toner or the like) is calculated as described below.

The measuring apparatus is a precision particle size distribution analyzer “Coulter Counter Multisizer 3” (registered trademark, manufactured by Beckman Coulter, Inc.) equipped with a 100-μm aperture tube utilizing an aperture impedance method.

Accessory dedicated software “Beckman Coulter, Multisizer 3 Version 3.51” (manufactured by Beckman Coulter, Inc.) is used to set the measurement conditions and analyze measured data. The effective measuring channel number is 25,000.

An aqueous electrolyte used for the measurement may be 1.0% special grade sodium chloride dissolved in deionized water, for example, “ISOTON II” (manufactured by Beckman Coulter, Inc.).

Before the measurement and analysis, the dedicated software is set up as described below.

On the “Standard operation mode (SOMME) setting” screen of the dedicated software, the total count number in control mode is set at 50,000 particles, the number of measurements is set at 1, and the Kd value is set at a value obtained with “standard particles 10.0 μm” (manufactured by Beckman Coulter, Inc.). A “Threshold/noise level measurement button” is pushed to automatically set the threshold and noise level. The current is set at 1,600 pA, the gain is set at 2, Isoton II is chosen as an electrolyte solution, and “Flushing of aperture tube after measurement” is checked.

On the “Conversion setting of pulse to particle diameter” screen of the dedicated software, the bin interval is set to the logarithmic particle diameter, the particle diameter bin is set to a 256 particle diameter bin, and the particle diameter range is set at 2 μm to 60 μm.

The specific measurement method is described below.
(1) A 250-ml round-bottom glass beaker specifically for Multisizer 3 is charged with approximately 200.0 mL of the aqueous electrolyte and is placed on a sample stand. A stirrer rod is rotated counterclockwise at 24 revolutions per second. Soiling and air bubbles in the aperture tube are removed using the “Aperture tube flushing” function of the dedicated software.
(2) A 100-mL flat-bottom glass beaker is charged with approximately 30.0 mL of the aqueous electrolyte. To the aqueous electrolyte is added 0.3 mL of a dispersant “Contaminon N” (a 10% aqueous neutral detergent for cleaning precision measuring instruments composed of a nonionic surfactant, an anionic surfactant, and an organic builder, pH 7, manufactured by Wako Pure Chemical Industries, Ltd.) diluted 3-fold by mass with deionized water.
(3) An ultrasonic disperser “Ultrasonic Dispersion System Tetra 150” (manufactured by Nikkaki-Bios Co., Ltd.) is prepared. The ultrasonic disperser includes two oscillators with an oscillation frequency of 50 kHz and has an electrical output of 120 W. The two oscillators have a phase difference of 180 degrees. A water tank of the ultrasonic disperser is charged with 3.3 L of deionized water, and 2.0 mL of Contaminon N is added to the water tank.
(4) The beaker in (2) is placed in a beaker-holding hole in the ultrasonic disperser, and the ultrasonic disperser is actuated. The vertical position of the beaker is adjusted such that the surface resonance of the aqueous electrolyte in the beaker is highest.
(5) While the aqueous electrolyte in the beaker in (4) is exposed to ultrasonic waves, 10 mg of toner or the like is added little by little to the aqueous electrolyte and is dispersed. The ultrasonic dispersion treatment is continued for another 60 seconds. During the ultrasonic dispersion, the water temperature of the water tank is controlled at 10° C. or more and 40° C. or less.
(6) The aqueous electrolyte containing dispersed toner or the like prepared in (5) is added dropwise with a pipette into the round-bottom beaker prepared in (1) placed on the sample stand such that the measurement concentration is 5%. The measurement is continued until the number of measured particles reaches 50,000.
(7) The measured data are analyzed using the accessory dedicated software to determine the weight-average particle diameter (D4). The “Average diameter” on the “Analysis/volume statistics (arithmetic mean)” screen in the setting of graph/volume percent in the dedicated software is the weight-average particle diameter (D4).

### EXAMPLES

The present disclosure is more specifically described in the following Examples. However, this does not limit the present disclosure in any way. A toner and a method for producing the toner are described below. Unless otherwise specified, “part(s)” and “%” in the examples and comparative examples are all based on mass.

### <Production Example of Fine-Bubble-Containing Water>

### [Fine-Bubble-Containing Water 1]

Deionized water containing dissolved air was prepared and was passed through a UP0290M 100-V motor type fine bubble producing apparatus (manufactured by Shibata Co., Ltd.) to produce fine-bubble-containing water 1. Fine bubbles thus produced had a number-average particle diameter of 1.5×10² (nm), a number concentration of 1.7×10⁶ (particles/mL), and a zeta potential of −22 mV. Table 1 shows physical properties of the fine-bubble-containing water 1.

### [Fine-Bubble-Containing Water 2]

Deionized water containing dissolved air was prepared, a pipe having a glass filter P100 for processing with a pore size in the range of 40 to 100 μm (manufactured by Sibata Scientific Technology Ltd.) was prepared in the deionized water, and air was allowed to flow into the pipe at a pressure of 0.2 MPa to produce fine-bubble-containing water 2. Fine bubbles thus produced had a number-average particle diameter of 9.2×10⁴ (nm), a number concentration of 1.3×10⁵ (particles/mL), and a zeta potential of −22 mV. Table 1 shows physical properties of the fine-bubble-containing water 2.

### [Fine-Bubble-Containing Waters 3 and 4]

Fine-bubble-containing waters 3 and 4 were produced in the same manner as in the production example of the fine-bubble-containing water 2 except that the filter type and the pore size were changed to those shown in Table 1. Table 1 shows physical properties of the fine-bubble-containing waters 3 and 4.

### [Fine-Bubble-Containing Water 5]

Air ultrafine bubble (nanobubble) water (manufactured by Nanox Co., Ltd.) was diluted 5000 times with deionized water to produce fine-bubble-containing water 5. Fine bubbles thus produced had a number-average particle diameter of 5.5×10¹ (nm), a number concentration of 1.7×10⁶ (particles/mL), and a zeta potential of −22 mV. Table 1 shows physical properties of the fine-bubble-containing water 5.

### [Fine-Bubble-Containing Water 6]

Fine-bubble-containing water 6 was produced in the same manner as in the production example of the fine-bubble-containing water 1 except that deionized water in which oxygen was dissolved by bubbling oxygen gas was used instead of the deionized water containing dissolved air. Table 1 shows physical properties of the fine-bubble-containing water 6.

### [Fine-Bubble-Containing Water 7]

Fine-bubble-containing water 7 was produced in the same manner as in the production example of the fine-bubble-containing water 1 except that deionized water in which nitrogen was dissolved by bubbling nitrogen gas was used instead of the deionized water containing dissolved air. Table 1 shows physical properties of the fine-bubble-containing water 7.

### [Fine-Bubble-Containing Water 8]

10% aqueous HCl was added to the fine-bubble-containing water 7 to adjust the pH to 4.0, thereby producing fine-bubble-containing water 8. Table 1 shows physical properties of the fine-bubble-containing water 8.

### [Fine-Bubble-Containing Water 9]

The fine-bubble-containing water 1 was diluted 150 times with deionized water to produce fine-bubble-containing water 9. Table 1 shows physical properties of the fine-bubble-containing water 9.

### [Fine-Bubble-Containing Water 10]

The fine-bubble-containing water 1 was diluted 350 times with deionized water to produce fine-bubble-containing water 10. Table 1 shows physical properties of the fine-bubble-containing water 10.

### [Fine-Bubble-Containing Water 11]

Fine-bubble-containing water 11 was produced in the same manner as in the production example of the fine-bubble-containing water 2 except that the gas to be dissolved and the gas to be allowed to flow in in the production example of the fine-bubble-containing water 2 were changed from air to nitrogen, and the pH was adjusted to 4.0 by adding 10% aqueous HCl. Table 1 shows physical properties of the fine-bubble-containing water.

### [Fine-Bubble-Containing Water 12]

10% aqueous HCl was added to the fine-bubble-containing water 11 to adjust the pH to 3.0, thereby producing fine-bubble-containing water 12. Table 1 shows physical properties of the fine-bubble-containing water.

### [Fine-Bubble-Containing Water 13]

Fine-bubble-containing water 13 was produced in the same manner as in the production example of the fine-bubble-containing water 11 except that the filter pore size was changed to that shown in Table 1. Table 1 shows physical properties of the fine-bubble-containing water 13.

TABLE 1

| | Number- | | | | | | | |
|---|---|---|---|---|---|---|---|---|
| Water | average | | | | | | | |
| containing | particle | Zeta | Number | | | | Filter pore | Principle of |
| fine bubbles | diameter | potential | concentration | Dissolved | | | size | fine bubble |
| No. | (nm) | (mV) | (particles/mL) | gas | pH | Filter type | (μm) | generation |
| 1 | 1.5 × 10² | −22 | 1.7 × 10⁶ | air | 7.0 | none | none | cavitation |
| 2 | 9.2 × 10⁴ | −22 | 1.3 × 10⁵ | air | 7.0 | glass filter for | 40-100 | fluid shear |
| | | | | | | processing | | |
| 3 | 1.2 × 10³ | −22 | 1.3 × 10⁶ | air | 7.0 | SPG filter | 15 | fluid shear |
| 4 | 9.5 × 10² | −22 | 1.5 × 10⁶ | air | 7.0 | SPG filter | 10 | fluid shear |
| 5 | 5.5 × 10¹ | −22 | 1.7 × 10⁶ | air | 7.0 | none | none | — |
| 6 | 1.3 × 10² | −45 | 1.7 × 10⁶ | oxygen | 7.0 | none | none | cavitation |
| 7 | 1.6 × 10² | −16 | 1.7 × 10⁶ | nitrogen | 7.0 | none | none | cavitation |
| 8 | 1.8 × 10² | −5 | 1.7 × 10⁶ | nitrogen | 4.0 | none | none | cavitation |
| 9 | 1.5 × 10² | −22 | 1.2 × 10⁴ | air | 7.0 | none | none | cavitation |
| 10 | 1.5 × 10² | −22 | 5.0 × 10³ | air | 7.0 | none | none | cavitation |
| 11 | 9.0 × 10⁴ | −5 | 1.3 × 10⁵ | nitrogen | 4.0 | glass filter for | 40-100 | fluid shear |
| | | | | | | processing | | |
| 12 | 9.1 × 10⁴ | 5 | 1.3 × 10⁵ | nitrogen | 3.0 | glass filter for | 40-100 | fluid shear |
| | | | | | | processing | | |
| 13 | 1.3 × 10⁵ | −5 | 1.1 × 10⁵ | nitrogen | 4.0 | glass filter for | 100-160 | fluid shear |
| | | | | | | processing | | |

* “SPG filter” in “Filter type” indicates the use of an SPG membrane filter (manufactured by SPG Technology Co., Ltd.) with a filter pore size shown in the table.

### Production Example of Resin Particle Dispersion Liquid

### [Resin Particle Dispersion Liquid 1]

### Production of Aqueous Medium

Deionized water 390.0 parts
Sodium phosphate (dodecahydrate) 14.0 parts

These materials were charged into a reaction vessel and were kept at 60° C. for 1.0 hour while purging with nitrogen.

While stirring at 12,000 rpm using a homomixer (manufactured by Primix Corporation), an aqueous calcium chloride containing 9.2 parts of calcium chloride (dihydrate) dissolved in 10.0 parts of deionized water was added thereto at once to prepare an aqueous medium containing hydroxyapatite as a dispersion stabilizer. Furthermore, 1 mol/L of hydrochloric acid was added thereto to adjust the pH to 6.0 to prepare an aqueous medium.

### Production of Polymerizable Monomer Composition

Polymerizable monomer: styrene 60.0 parts
Colorant: C.I. Pigment Blue 15:3 6.5 parts

These materials were charged into an attritor (manufactured by Nippon Coke & Engineering Co., Ltd.) and were dispersed at 220 rpm for 5.0 hours using zirconia particles with a diameter of 1.7 mm to prepare a colorant dispersion liquid containing the dispersed pigment.

The following materials were added to the colorant dispersion liquid.
Polymerizable monomer: styrene 20.0 parts
Polymerizable monomer: n-butyl acrylate 20.0 parts
Resin with carboxy group: polyester resin 5.0 parts
(Condensation product of 2-mole propylene oxide adduct of bisphenol A/ethylene glycol/isosorbide/terephthalic acid/trimellitic acid, glass transition temperature Tg: 75° C., acid value: 5.0 mgKOH/g)
   Plasticizer: ethylene glycol distearate (melting point: 73° C.) 9.0 parts
   Release agent: Fischer-Tropsch wax (melting point: 78° C.) 5.0 parts

These materials were kept at 65° C. and were uniformly dissolved and dispersed using the homomixer at 500 rpm to prepare a polymerizable monomer composition.

### Granulation Step

While maintaining the temperature of the aqueous medium at 60° C. and the rotation speed of the homomixer at 12,000 rpm, the polymerizable monomer composition and 7.0 parts of a polymerization initiator t-butyl peroxypivalate were added to the aqueous medium.

Granulation was continued for 10 minutes while maintaining 12,000 rpm.

### Polymerization Step

The homomixer was changed to an agitator equipped with a propeller blade, and the temperature was raised to 70° C. over 30 minutes while stirring at 150 rpm. Polymerization was performed for 4.0 hours while maintaining the temperature at 70° C., and the temperature was further raised to 85° C., followed by heating for 0.5 hours to perform a polymerization reaction. Cold water of 2° C. was then charged, followed by cooling to 30° C. at a cooling rate of 4° C./s. The temperature was then raised to 50° C. and was maintained for 4.0 hours while stirring at 150 rpm. The temperature was lowered to 30° C. to prepare a slurry in which resin particles were dispersed.

### Dispersant Removal Step

10% aqueous HCl was added to the slurry to adjust the pH to 2.0, and the slurry was stirred at 150 rpm for 1 hour to dissolve the dispersant on the surface of the resin particles. Deionized water was added to adjust the resin particle concentration in the dispersion liquid to 20.0%, thereby preparing a resin particle dispersion liquid 1 in which resin particles 1 were dispersed.

The resin particles 1 had a weight-average particle diameter (D4) of 6.7 μm, an acid value of 0.15 mgKOH/g on the surface of the resin particles, an average circularity of 0.985, and a glass transition temperature (Tg) of 56° C. It was also found that the resin particles 2 contained, as a metal ion, a calcium ion (Ca²⁺) derived from calcium chloride and had a structure of —(COO⁻)₂Ca²⁺. The calcium ion content was 0.0030 mg per gram of the resin particles. Table 2 shows physical properties of the resin particles 1.

### [Resin Particle Dispersion Liquid 2]

### Fine Resin Particle Dispersion Liquid

Resin with a carboxy group: polyester resin 200 parts
(Condensation product of 2-mole propylene oxide adduct of bisphenol A/ethylene glycol/isosorbide/terephthalic acid/trimellitic acid, glass transition temperature Tg: 75° C., acid value: 5.0 mgKOH/g)
   Deionized water 500 parts

These materials are placed in a stainless steel vessel, are heated and melted to 95° C. in a hot bath, and 0.1 mol/L sodium hydrogen carbonate is added to increase the pH to more than 7.0 while sufficiently stirring the materials at 7800 rpm using a homogenizer (manufactured by IKA: Ultra-Turrax T50). A mixed solution of 3 parts of sodium dodecylbenzene sulfonate and 297 parts of deionized water was gradually added dropwise thereto and was emulsified and dispersed to prepare a fine resin particle dispersion liquid. The fine resin particle dispersion liquid had a solid concentration of 20%.

When the particle size distribution of the fine resin particle dispersion liquid was measured with a particle size analyzer (LA-960V2 manufactured by Horiba, Ltd.), the fine resin particles had a number-average particle diameter of 0.25 μm, and coarse particles of more than 1 μm were not observed.

### Fine Plasticizer Particle Dispersion Liquid

Deionized water 500 parts
Plasticizer (ethylene glycol distearate (melting point: 73° C.)) 200 parts

These materials were placed in a stainless steel vessel, were heated and melted to 95° C. in a hot bath, and 0.1 mol/L sodium hydrogen carbonate was added to increase the pH to more than 7.0 while sufficiently stirring the materials at 7800 rpm using a homogenizer (manufactured by IKA: Ultra-Turrax T50).

A mixed solution of 5 parts of sodium dodecylbenzene sulfonate and 295 parts of deionized water was gradually added dropwise thereto and was emulsified and dispersed to prepare a fine plasticizer particle dispersion liquid. The fine plasticizer particle dispersion liquid had a solid concentration of 20%. When the particle size distribution of fine release agent particles in the fine plasticizer particle dispersion liquid was measured with a particle size analyzer (LA-960V2 manufactured by Horiba, Ltd.), the fine plasticizer particles had a number-average particle diameter of 0.35 μm, and coarse particles of more than 1 μm were not observed.

### Fine Colorant Particle Dispersion Liquid

Colorant: C.I. Pigment Blue 15:3 100 parts
Sodium dodecylbenzene sulfonate 5 parts
Deionized water 400 parts

These materials were mixed and dispersed with a sand grinder mill to prepare a fine colorant particle dispersion liquid. The fine colorant particle dispersion liquid had a solid concentration of 20%. When the particle size distribution of colorant particles in the fine colorant particle dispersion liquid was measured with a particle size analyzer (LA-960V2 manufactured by Horiba, Ltd.), the fine colorant particles had a number-average particle diameter of 0.20 μm, and coarse particles of more than 1 μm were not observed.

### Resin Particle Dispersion Liquid

Fine resin particle dispersion liquid 500 parts
Fine colorant particle dispersion liquid 50 parts
Fine plasticizer particle dispersion liquid 50 parts
Sodium dodecylbenzene sulfonate 5 parts

The fine resin particle dispersion liquid, the fine plasticizer particle dispersion liquid, and sodium dodecylbenzene sulfonate were charged into a reactor (a flask with a volume of 1 liter, an anchor blade with a baffle) and were homogeneously mixed. On the other hand, the fine colorant particle dispersion liquid was homogeneously mixed in a 500-mL beaker and was gradually added to the reactor with stirring to prepare a mixed dispersion liquid. While stirring the mixed dispersion liquid, 0.5 parts of aqueous aluminum sulfate in terms of solid content was added dropwise thereto to form an agglomerate.

After completion of the dropwise addition, the system was purged with nitrogen and was kept at 50° C. for 1 hour and then at 55° C. for 1 hour.

The temperature was then raised and maintained at 90° C. for 30 minutes. The temperature was lowered to 63° C. and was then maintained for 3 hours to form fused particles.

The reaction was performed in a nitrogen atmosphere. After a predetermined time, the temperature was lowered to 30° C. at a temperature decrease rate of 4.0° C./min. The temperature was then raised to 50° C. and was maintained for 4.0 hours while stirring at 150 rpm. The temperature was lowered to 30° C., and deionized water was added to adjust the solid concentration to 20%, thereby preparing a resin particle dispersion liquid 2 in which resin particles 2 were dispersed.

The resin particles 2 had a weight-average particle diameter (D4) of 6.7 μm, an acid value of 0.15 mgKOH/g on the surface of the resin particles, an average circularity of 0.965, and a glass transition temperature (Tg) of 65° C. It was also found that the resin particles 1 contained, as a metal ion, an aluminum ion (Al³⁺) derived from aluminum sulfate and had a structure of —(COO⁻)₃Al³⁺. The aluminum ion content per gram of the resin particles was 0.0040 mg/g. Table 2 shows physical properties of the resin particles 2.

### [Resin Particle Dispersion Liquid 3]

A resin particle dispersion liquid 3 was produced in the same manner as in the production example of the resin particle dispersion liquid 2 except that the polyester used in the production example of the resin particle dispersion liquid 2 was changed to the following. Table 2 shows physical properties of resin particles 3.

Polyester resin: a condensation product of a 2-mole propylene oxide adduct of bisphenol A/ethylene glycol/isosorbide/terephthalic acid/trimellitic acid, glass transition temperature Tg: 75° C., acid value: 30.0 mgKOH/g

[Resin particle dispersion liquid 4]

A resin particle dispersion liquid 4 was produced in the same manner as in the production example of the resin particle dispersion liquid 2 except that the polyester used in the production example of the resin particle dispersion liquid 2 was changed to the following. Table 2 shows physical properties of resin particles 4.

Polyester resin: a condensation product of a 2-mole propylene oxide adduct of bisphenol A/ethylene glycol/isosorbide/terephthalic acid/trimellitic acid, glass transition temperature Tg: 75° C., acid value: 1.0 mgKOH/g

### [Resin Particle Dispersion Liquid 5]

A resin particle dispersion liquid 5 was produced in the same manner as in the production example of the resin particle dispersion liquid 2 except that the polyester used in the production example of the resin particle dispersion liquid 2 was changed to the following. Table 2 shows physical properties of resin particles 5.

Polyester resin: a condensation product of a 2-mole propylene oxide adduct of bisphenol A/ethylene glycol/isosorbide/terephthalic acid/trimellitic acid, glass transition temperature Tg: 75° C., acid value: 0.5 mgKOH/g

### [Resin Particle Dispersion Liquid 6]

A resin particle dispersion liquid 6 was produced in the same manner as in the production example of the resin particle dispersion liquid 2 except that the temperature in the step of holding at 90° C. for 30 minutes in the production example of the resin particle dispersion liquid 2 was changed to 70° C. Table 2 shows physical properties of resin particles 6.

### [Resin Particle Dispersion Liquid 7]

A resin particle dispersion liquid 7 was produced in the same manner as in the production example of the resin particle dispersion liquid 1 except that the polyester resin and the plasticizer used in the production example of the resin particle dispersion liquid 1 were changed to the following. Table 2 shows physical properties of the resin particles 7.

Polyester resin: a condensation product of a 2-mole propylene oxide adduct of bisphenol A/terephthalic acid/trimellitic acid, glass transition temperature Tg: 70° C., acid value: 8.0 mgKOH/g Plasticizer: behenyl stearate (melting point: 68° C.)

### [Resin Particle Dispersion Liquid 8]

A resin particle dispersion liquid 8 was produced in the same manner as in the production example of the resin particle dispersion liquid 2 except that the amount of aluminum sulfate used in the production example of the resin particle dispersion liquid 2 was changed to 0.8 parts. Table 2 shows physical properties of resin particles 8.

### [Resin Particle Dispersion Liquid 9]

A resin particle dispersion liquid 9 was produced in the same manner as in the production example of the resin particle dispersion liquid 2 except that the amount of aluminum sulfate used in the production example of the resin particle dispersion liquid 2 was changed to 1.0 part. Table 2 shows physical properties of resin particles 9. [Resin Particle Dispersion Liquid 10]

A resin particle dispersion liquid 10 was produced in the same manner as in the production example of the resin particle dispersion liquid 2 except that the polyester used in the production example of the resin particle dispersion liquid 2 was changed to the following. Table 2 shows physical properties of resin particles 10. In this example, a terminal carboxy group of the polyester resin is capped with stearyl alcohol, and the structure of —(COO⁻)₃Al³⁺ is not observed on the surface of the resin particles 10 (amount of ion: 0.0000 mg/g).

Polyester resin: a condensation product of a 2-mole propylene oxide adduct of bisphenol A/ethylene glycol/isosorbide/terephthalic acid/trimellitic acid, a terminal carboxy group is capped with stearyl alcohol, glass transition temperature Tg: 75° C., acid value: 0.0 mgKOH/g

TABLE 2

| | | | | | Glass | Weight- | |
|---|---|---|---|---|---|---|---|
| | | | | | transition | average | |
| | | Amount | Acid value of | | temper- | particle | |
| | Ionic | of ion | surface | Average | ature | diameter | |
| | species | (mg/g) | (mgKOH/g) | circularity | (° C.) | (μm) | Production method |
| Resin particles 1 | Ca²⁺ | 0.0030 | 0.15 | 0.985 | 56 | 6.7 | suspension polymerization |
| Resin particles 2 | Al³⁺ | 0.0040 | 0.15 | 0.965 | 65 | 6.7 | emulsion aggregation |
| Resin particles 3 | Al³⁺ | 0.0050 | 0.90 | 0.965 | 65 | 6.7 | emulsion aggregation |
| Resin particles 4 | Al³⁺ | 0.0020 | 0.03 | 0.965 | 65 | 6.7 | emulsion aggregation |
| Resin particles 5 | Al³⁺ | 0.0015 | 0.01 | 0.965 | 65 | 6.7 | emulsion aggregation |
| Resin particles 6 | Al³⁺ | 0.0040 | 0.15 | 0.955 | 65 | 6.7 | emulsion aggregation |
| Resin particles 7 | Ca²⁺ | 0.0030 | 0.20 | 0.985 | 56 | 6.7 | suspension polymerization |
| Resin particles 8 | Al³⁺ | 0.0065 | 0.15 | 0.965 | 65 | 6.7 | emulsion aggregation |
| Resin particles 9 | Al³⁺ | 0.0080 | 0.15 | 0.965 | 65 | 6.7 | emulsion aggregation |
| Resin particles 10 | Al³⁺ | 0.0000 | 0.00 | 0.965 | 65 | 6.7 | emulsion aggregation |

### Production Example of Toner

### [Toner 1]

### Washing Step

Wet toner particles 1 were produced through a washing step under the following conditions using a vacuum horizontal belt filter (manufactured by Hitachi Zosen Corporation), which is a washing apparatus that continuously performs washing while transferring a cake to be washed.
Slurry supplied: resin particle dispersion liquid 1
Washing liquid: fine-bubble-containing water 1
Washing liquid temperature: 40° C.
Slurry feed rate: 10 kg/h
Washing liquid feed rate: 4 kg/h
Belt speed: operated at stop time/moving time=10/1, 0.2 m/min on average
Filter cloth: made of polyester
Degree of vacuum: −70 kPa

In the washing step, the ratio P/W of the mass P of resin particles to the mass W of washing liquid was 0.50, and the ratio M/W of the mass M of ion to the mass W of washing liquid was 2.0×10⁻⁶. The resulting wet cake was then crushed into wet toner particles 1.

After the washing step for 10 hours, a sample of the filter cloth was collected and checked for clogging using an optical microscope. The clogging was rated according to the following evaluation criteria.

### <Clogging>

A: No salt causing clogging is observed in the opening.
B: Salt is slightly observed in the opening, but the opening is sufficiently secured.
C: Salt is observed in the opening, but no clogging is observed.
D: Salt is observed in the opening, and clogging is partially observed.

The amount of washing liquid required to produce 10 kg of toner was rated according to the following criteria.

### <Amount of Washing Liquid>

A: The amount of washing liquid used is less than 40 kg
B: The amount of washing liquid used is 40 kg or more and less than 80 kg
C: The amount of washing liquid used is 80 kg or more and less than 160 kg
D: The amount of washing liquid used is 160 kg or more

Table 5 shows the evaluation results.

### Drying Step

A drying step was then performed under the following conditions using a jet turbo dryer (manufactured by Hiraiwa Iron Works Co., Ltd.), which is a loop airflow dryer, to produce toner particles 1.
Blowing temperature: 70° C.
Blowing volume: 1 m³/min
Wet toner particle feed rate: 5 kg/h

The amount of wax on the surface of the toner particles 1 was 0%, and the amount of metal ion was 0.0005 mg/g. Table 4 shows physical properties of the toner particles 1.

### External Addition Step

Toner particles 1 100.0 parts
Silica particles (RX200: primary average particle diameter 12 nm, treated with HMDS, manufactured by Nippon Aerosil Co., Ltd.) 1.5 parts

These materials were externally added and mixed using FM10C (manufactured by Nippon Coke & Engineering Co., Ltd.). For external addition conditions, a lower blade was a AG blade, the distance of a deflector from the wall was 20 mm, the amount of toner particles charged was 2.0 kg, the rotation speed was 66.6 s⁻¹, the external addition time was 10 minutes, and the temperature and flow rate of the cooling water were 20° C. and 10 L/min, respectively.

The product was then sieved through a mesh with an opening of 37 μm to prepare toner 1. Tables 4-1 and 4-2 show physical properties of the toner 1.

### [Toners 2 to 33]

Toner particles 2 to 33 and toners 2 to 33 were produced in the same manner as in the production example of the toner 1 except that the conditions in the production example of the toner 1 were changed to those shown in Table 3. Table 4 shows the physical properties of the toner particles 2 to 33. Table 5 shows the evaluation of clogging and the amount of washing liquid in the washing step of the toner particles 2 to 33.

TABLE 3

| | | | Washing | Slurry | Washing | Amount of |
|---|---|---|---|---|---|---|
| | | | liquid | feed | liquid feed | washing |
| | | | temperature | rate | rate | liquid |
| Toner | Slurry supplied | Washing liquid | (° C.) | (kg/h) | (kg/h) | (kg) |
| Toner 1 | resin particle dispersion liquid 1 | fine-bubble-containing water 1 | 40 | 10 | 4 | 20.0 |
| Toner 2 | resin particle dispersion liquid 1 | fine-bubble-containing water 2 | 40 | 10 | 4 | 20.0 |
| Toner 3 | resin particle dispersion liquid 1 | fine-bubble-containing water 3 | 40 | 10 | 4 | 20.0 |
| Toner 4 | resin particle dispersion liquid 1 | fine-bubble-containing water 4 | 40 | 10 | 4 | 20.0 |
| Toner 5 | resin particle dispersion liquid 1 | fine-bubble-containing water 5 | 40 | 10 | 4 | 20.0 |
| Toner 6 | resin particle dispersion liquid 1 | fine-bubble-containing water 6 | 40 | 10 | 4 | 20.0 |
| Toner 7 | resin particle dispersion liquid 1 | fine-bubble-containing water 7 | 40 | 10 | 4 | 20.0 |
| Toner 8 | resin particle dispersion liquid 1 | fine-bubble-containing water 8 | 40 | 10 | 4 | 20.0 |
| Toner 9 | resin particle dispersion liquid 1 | fine-bubble-containing water 9 | 40 | 10 | 4 | 20.0 |
| Toner 10 | resin particle dispersion liquid 1 | fine-bubble-containing water 10 | 40 | 10 | 4 | 20.0 |
| Toner 11 | resin particle dispersion liquid 2 | fine-bubble-containing water 1 | 40 | 10 | 4 | 20.0 |
| Toner 12 | resin particle dispersion liquid 3 | fine-bubble-containing water 1 | 40 | 10 | 4 | 20.0 |
| Toner 13 | resin particle dispersion liquid 4 | fine-bubble-containing water 1 | 40 | 10 | 4 | 20.0 |
| Toner 14 | resin particle dispersion liquid 5 | fine-bubble-containing water 1 | 40 | 10 | 4 | 20.0 |
| Toner 15 | resin particle dispersion liquid 6 | fine-bubble-containing water 1 | 40 | 10 | 4 | 20.0 |
| Toner 16 | resin particle dispersion liquid 7 | fine-bubble-containing water 1 | 55 | 10 | 4 | 20.0 |
| Toner 17 | resin particle dispersion liquid 7 | fine-bubble-containing water 1 | 50 | 10 | 4 | 20.0 |
| Toner 18 | resin particle dispersion liquid 7 | fine-bubble-containing water 1 | 45 | 10 | 4 | 20.0 |
| Toner 19 | resin particle dispersion liquid 7 | fine-bubble-containing water 1 | 35 | 10 | 4 | 20.0 |
| Toner 20 | resin particle dispersion liquid 7 | fine-bubble-containing water 1 | 30 | 10 | 4 | 20.0 |
| Toner 21 | resin particle dispersion liquid 7 | fine-bubble-containing water 1 | 25 | 10 | 4 | 20.0 |
| Toner 22 | resin particle dispersion liquid 2 | fine-bubble-containing water 1 | 40 | 24 | 4 | 8.3 |
| Toner 23 | resin particle dispersion liquid 2 | fine-bubble-containing water 1 | 40 | 16 | 4 | 12.5 |
| Toner 24 | resin particle dispersion liquid 2 | fine-bubble-containing water 1 | 40 | 3 | 4 | 66.7 |
| Toner 25 | resin particle dispersion liquid 2 | fine-bubble-containing water 1 | 40 | 1.6 | 4 | 125.0 |
| Toner 26 | resin particle dispersion liquid 8 | fine-bubble-containing water 1 | 40 | 10 | 4 | 20.0 |
| Toner 27 | resin particle dispersion liquid 9 | fine-bubble-containing water 1 | 40 | 10 | 4 | 20.0 |
| Toner 28 | resin particle dispersion liquid 2 | fine-bubble-containing water 11 | 40 | 10 | 4 | 20.0 |
| Toner 29 | resin particle dispersion liquid 2 | deionized water | 40 | 10 | 4 | 20.0 |
| Toner 30 | resin particle dispersion liquid 2 | deionized water | 40 | 1.2 | 4 | 166.7 |
| Toner 31 | resin particle dispersion liquid 10 | fine-bubble-containing water 1 | 40 | 10 | 4 | 20.0 |
| Toner 32 | resin particle dispersion liquid 2 | fine-bubble-containing water 12 | 40 | 10 | 4 | 20.0 |
| Toner 33 | resin particle dispersion liquid 2 | fine-bubble-containing water 13 | 40 | 10 | 4 | 20.0 |

* “Deionized water” in “Washing liquid” indicates the use of deionized water containing no fine bubbles.

TABLE 4-1

| | | | | | Fine bubbles | | | |
|---|---|---|---|---|---|---|---|---|
| | | | | | | Number- | | |
| | Resin particles | | | | | average | | |
| | Presence or | Amount | | | | particle | Zeta | Number |
| | absence of | of ion | Acid value | Average | Presence or | diameter | potential | concentration |
| | —(COO⁻)ₙAⁿ⁺ | (mg/g) | (mgKOH/g) | circularity | absence | (nm) | (mV) | (particles/mL) |
| Toner 1 | present | 0.003 | 0.15 | 0.985 | present | 1.5 × 10² | −22 | 1.7 × 10⁶ |
| Toner 2 | present | 0.003 | 0.15 | 0.985 | present | 9.2 × 10⁴ | −22 | 1.3 × 10⁵ |
| Toner 3 | present | 0.003 | 0.15 | 0.985 | present | 1.2 × 10³ | −22 | 1.3 × 10⁶ |
| Toner 4 | present | 0.003 | 0.15 | 0.985 | present | 9.5 × 10² | −22 | 1.5 × 10⁶ |
| Toner 5 | present | 0.003 | 0.15 | 0.985 | present | 5.5 × 10¹ | −22 | 1.7 × 10⁶ |
| Toner 6 | present | 0.003 | 0.15 | 0.985 | present | 1.3 × 10² | −45 | 1.7 × 10⁶ |
| Toner 7 | present | 0.003 | 0.15 | 0.985 | present | 1.6 × 10² | −16 | 1.7 × 10⁶ |
| Toner 8 | present | 0.003 | 0.15 | 0.985 | present | 1.8 × 10² | −5 | 1.7 × 10⁶ |
| Toner 9 | present | 0.003 | 0.15 | 0.985 | present | 1.5 × 10² | −22 | 1.2 × 10⁴ |
| Toner 10 | present | 0.003 | 0.15 | 0.985 | present | 1.5 × 10² | −22 | 5.0 × 10³ |
| Toner 11 | present | 0.004 | 0.15 | 0.965 | present | 1.5 × 10² | −22 | 1.7 × 10⁶ |
| Toner 12 | present | 0.065 | 0.90 | 0.965 | present | 1.5 × 10² | −22 | 1.7 × 10⁶ |
| Toner 13 | present | 0.002 | 0.03 | 0.965 | present | 1.5 × 10² | −22 | 1.7 × 10⁶ |
| Toner 14 | present | 0.015 | 0.01 | 0.965 | present | 1.5 × 10² | −22 | 1.7 × 10⁶ |
| Toner 15 | present | 0.004 | 0.15 | 0.955 | present | 1.5 × 10² | −22 | 1.7 × 10⁶ |
| Toner 16 | present | 0.003 | 0.20 | 0.985 | present | 1.5 × 10² | −22 | 1.7 × 10⁶ |
| Toner 17 | present | 0.003 | 0.20 | 0.985 | present | 1.5 × 10² | −22 | 1.7 × 10⁶ |
| Toner 18 | present | 0.003 | 0.20 | 0.985 | present | 1.5 × 10² | −22 | 1.7 × 10⁶ |
| Toner 19 | present | 0.003 | 0.20 | 0.985 | present | 1.5 × 10² | −22 | 1.7 × 10⁶ |
| Toner 20 | present | 0.003 | 0.20 | 0.985 | present | 1.5 × 10² | −22 | 1.7 × 10⁶ |
| Toner 21 | present | 0.003 | 0.20 | 0.985 | present | 1.5 × 10² | −22 | 1.7 × 10⁶ |
| Toner 22 | present | 0.004 | 0.15 | 0.965 | present | 1.5 × 10² | −22 | 1.7 × 10⁶ |
| Toner 23 | present | 0.004 | 0.15 | 0.965 | present | 1.5 × 10² | −22 | 1.7 × 10⁶ |
| Toner 24 | present | 0.004 | 0.15 | 0.965 | present | 1.5 × 10² | −22 | 1.7 × 10⁶ |
| Toner 25 | present | 0.004 | 0.15 | 0.965 | present | 1.5 × 10² | −22 | 1.7 × 10⁶ |
| Toner 26 | present | 0.065 | 0.15 | 0.965 | present | 1.5 × 10² | −22 | 1.7 × 10⁶ |
| Toner 27 | present | 0.008 | 0.15 | 0.965 | present | 1.5 × 10² | −22 | 1.7 × 10⁶ |
| Toner 28 | present | 0.004 | 0.15 | 0.965 | present | 9.0 × 10⁴ | −5 | 1.3 × 10⁵ |
| Toner 29 | present | 0.004 | 0.15 | 0.965 | absent | — | — | — |
| Toner 30 | present | 0.004 | 0.15 | 0.965 | absent | — | — | — |
| Toner 31 | absent | 0.000 | 0.00 | 0.965 | present | 1.5 × 10² | −22 | 1.7 × 10⁶ |
| Toner 32 | present | 0.004 | 0.15 | 0.965 | present | 9.1 × 10⁴ | 5 | 1.3 × 10⁵ |
| Toner 33 | present | 0.004 | 0.15 | 0.965 | present | 1.3 × 10⁶ | −5 | 1.1 × 10⁵ |

TABLE 4-2

| | Production conditions | | | Toner particles | | |
|---|---|---|---|---|---|---|
| | | | Washing | | | Ion |
| | | | liquid | | Amount | reduction |
| | | | temperature | Cw | of ion | ratio |
| | P/W | M/W | (° C.) | (%) | (mg/g) | (%) |
| Toner 1 | 0.5 | 2.0 × 10⁻⁶ | 40 | 0 | 0.0005 | 83.3 |
| Toner 2 | 0.5 | 2.0 × 10⁻⁶ | 40 | 2 | 0.0012 | 60.0 |
| Toner 3 | 0.5 | 2.0 × 10⁻⁶ | 40 | 1 | 0.0010 | 66.7 |
| Toner 4 | 0.5 | 2.0 × 10⁻⁶ | 40 | 0 | 0.0007 | 76.7 |
| Toner 5 | 0.5 | 2.0 × 10⁻⁶ | 40 | 0 | 0.0004 | 86.7 |
| Toner 6 | 0.5 | 2.0 × 10⁻⁶ | 40 | 6 | 0.0004 | 86.7 |
| Toner 7 | 0.5 | 2.0 × 10⁻⁶ | 40 | 0 | 0.0008 | 73.3 |
| Toner 8 | 0.5 | 2.0 × 10⁻⁶ | 40 | 0 | 0.0012 | 60.0 |
| Toner 9 | 0.5 | 2.0 × 10⁻⁶ | 40 | 2 | 0.0008 | 73.3 |
| Toner 10 | 0.5 | 2.0 × 10⁻⁶ | 40 | 3 | 0.0011 | 63.3 |
| Toner 11 | 0.5 | 2.7 × 10⁻⁶ | 40 | 3 | 0.0006 | 85.0 |
| Toner 12 | 0.5 | 4.3 × 10⁻⁶ | 40 | 3 | 0.0010 | 84.6 |
| Toner 13 | 0.5 | 1.3 × 10⁻⁶ | 40 | 3 | 0.0004 | 80.0 |
| Toner 14 | 0.5 | 1.0 × 10⁻⁶ | 40 | 3 | 0.0003 | 80.0 |
| Toner 15 | 0.5 | 2.7 × 10⁻⁶ | 40 | 3 | 0.0010 | 75.0 |
| Toner 16 | 0.5 | 2.0 × 10⁻⁶ | 55 | 6 | 0.0012 | 60.0 |
| Toner 17 | 0.5 | 2.0 × 10⁻⁶ | 50 | 4 | 0.0008 | 73.3 |
| Toner 18 | 0.5 | 2.0 × 10⁻⁶ | 45 | 2 | 0.0006 | 80.0 |
| Toner 19 | 0.5 | 2.0 × 10⁻⁶ | 35 | 0 | 0.0008 | 73.3 |
| Toner 20 | 0.5 | 2.0 × 10⁻⁶ | 30 | 0 | 0.0012 | 60.0 |
| Toner 21 | 0.5 | 2.0 × 10⁻⁶ | 25 | 0 | 0.0014 | 53.3 |
| Toner 22 | 1.2 | 6.4 × 10⁻⁶ | 40 | 3 | 0.0012 | 70.0 |
| Toner 23 | 0.8 | 4.3 × 10⁻⁶ | 40 | 3 | 0.0009 | 77.5 |
| Toner 24 | 0.15 | 8.0 × 10⁻⁷ | 40 | 3 | 0.0004 | 90.0 |
| Toner 25 | 0.08 | 4.3 × 10⁻⁷ | 40 | 3 | 0.0003 | 92.5 |
| Toner 26 | 0.5 | 4.3 × 10⁻⁶ | 40 | 3 | 0.0007 | 89.2 |
| Toner 27 | 0.5 | 5.3 × 10⁻⁶ | 40 | 3 | 0.0009 | 88.8 |
| Toner 28 | 0.5 | 2.7 × 10⁻⁶ | 40 | 5 | 0.0014 | 65.0 |
| Toner 29 | 0.5 | 2.7 × 10⁻⁶ | 40 | 12 | 0.0022 | 45.0 |
| Toner 30 | 0.04 | 3.2 × 10⁻⁷ | 40 | 12 | 0.0016 | 60.0 |
| Toner 31 | 0.5 | 0 | 40 | 0 | 0.0000 | — |
| Toner 32 | 0.5 | 2.7 × 10⁻⁶ | 40 | 0 | 0.0021 | 47.5 |
| Toner 33 | 0.5 | 2.7 × 10⁻⁶ | 40 | 4 | 0.0021 | 47.5 |

### Examples 1 to 28, Comparative Examples 1 to 5

The toners 1 to 33 in Table 5 were evaluated. Table 5 shows the evaluation results.

Evaluation methods and evaluation criteria in the present disclosure are described below.

As an image-forming apparatus, a modified apparatus of a commercially available laser printer LBP-712Ci (manufactured by CANON KABUSHIKI KAISHA) in which the process speed was 210 mm/s, and a commercially available process cartridge, toner cartridge 040H (cyan) (manufactured by CANON KABUSHIKI KAISHA), were used. Product toner was removed from the cartridge, and the cartridge was cleaned by air blowing and was then filled with 156 g of a toner according to the present disclosure. Product toner was removed from yellow, magenta, and black stations, and the evaluation was performed by inserting yellow, magenta, and black cartridges in which a remaining toner quantity detection mechanism was disabled.

### <H/H Fogging>

The modified apparatus and the process cartridge filled with toner produced by a production method according to the present disclosure were allowed to stand for 24 hours in a high-temperature and high-humidity environment (30° C./80% RH, hereinafter referred to as H/H environment).

In the H/H environment, a horizontal line image with a printing ratio of 1% was output on 3000 sheets of Canon color laser copy paper (A4: 81.4 g/m²) as a transferring material (printing paper) in a sequence of printing two sheets and pausing for 3 seconds.

After standing for 60 hours in the H/H environment, the process speed was changed to 70 mm/s, and an all-white image with 0% printing was output on one sheet of BROCHURE PAPER 150g GLOSSY paper (manufactured by HP: 150 g/m²) as an evaluation sheet. The fog density on the all-white image was calculated and rated according to the following criteria.

A “white photometer TC-6DS” (manufactured by Tokyo Denshoku Co., Ltd.) was used to calculate the fog density, and the difference between the whiteness degree of a white background portion (all-white image) of the evaluation sheet and the whiteness degree of the transferring material was calculated as the fog density (%). An amber filter was used as a filter. When toner has low chargeability, fogging is likely to occur due to development of the toner on the white background portion.

### Evaluation Criteria

A: Fog density of less than 0.5%
B: Fog density of 0.5% or more and less than 2.0%
C: Fog density of 2.0% or more and less than 5.0%
D: Fog density of 5.0% or more

### <H/H Charge Amount>

The same output was continuously performed, and printing was stopped during image formation. The process cartridge was taken out to measure the charge amount of toner on a developing roller immediately after passing through a control blade. The H/H charge amount was rated according to the following criteria.

The charge amount on the developing roller was measured with a Faraday cage illustrated in the perspective view of Figure. The inside (the right side in the figure) was brought into a low-pressure state so that the toner on the developing roller was sucked, and a toner filter 133 was provided to collect the toner. Reference numeral 131 denotes a suction unit, and reference numeral 132 denotes a holder. A charge amount Q/M (pC/g) per unit mass was calculated from the mass M of the collected toner and the electric charge Q directly measured with a coulomb meter, and an absolute value of the charge amount of the toner was ranked as a toner charge amount (Q/M) as described below. A large amount of metal ion on the toner surface tends to result in a decrease in chargeability due to the influence of moisture absorption. A small number of carboxy groups, which are charging sites, on the toner surface also tends to result in a decrease in charge amount.

### Evaluation Criteria

A: 40 μC/g or more
B: 30 μC/g or more and less than 40 μC/g
C: 20 μC/g or more and less than 30 μC/g
D: Less than 20 μC/g

### <Transfer Void>

After the charge amount evaluation, an 8-mm quadrille grid chart in which both vertical and horizontal lines were formed by lines with a width of 200 μm, 500 μm, 1 mm, or 2 mm was printed on both sides of BROCHURE PAPER 150g GLOSSY paper (manufactured by HP: 150 g/m²). Ten arbitrary points of the second side print were observed visually or with a magnifier (×30) and were classified into the following evaluation ranks. The release agent or the plasticizer exposed on the toner surface increases the adhesion strength of the toner to the drum and is likely to cause a transfer void.

### Evaluation Criteria

A: No transfer void.
B: The observation with the 30× magnifier shows a transfer void in a portion of the visual field.
C: The visual observation shows a partial transfer void.
D: The visual observation shows a transfer void on the whole.

TABLE 5

| | | Wash | | | H/H | Trans- |
|---|---|---|---|---|---|---|
| | | water | | H/H | charge | fer |
| | Toner | amount | Clogging | fogging | amount | void |
| Example 1 | toner 1 | A(20.0) | A | A(0.3) | A(45) | A |
| Example 2 | toner 2 | A(20.0) | A | B(1.6) | B(32) | A |
| Example 3 | toner 3 | A(20.0) | A | B(0.7) | B(38) | A |
| Example 4 | toner 4 | A(20.0) | A | A(0.3) | A(44) | A |
| Example 5 | toner 5 | A(20.0) | A | A(0.2) | A(46) | A |
| Example 6 | toner 6 | A(20.0) | A | A(0.2) | A(46) | C |
| Example 7 | toner 7 | A(20.0) | A | A(0.4) | A(43) | A |
| Example 8 | toner 8 | A(20.0) | A | B(1.7) | B(32) | B |
| Example 9 | toner 9 | A(20.0) | A | A(0.4) | A(43) | A |
| Example 10 | toner 10 | A(20.0) | A | B(1.0) | B(35) | A |
| Example 11 | toner 11 | A(20.0) | A | A(0.3) | A(44) | A |
| Example 12 | toner 12 | A(20.0) | A | B(0.7) | B(38) | A |
| Example 13 | toner 13 | A(20.0) | A | B(1.0) | B(35) | A |
| Example 14 | toner 14 | A(20.0) | A | C(2.8) | C(26) | A |
| Example 15 | toner 15 | A(20.0) | A | B(0.7) | B(38) | A |
| Example 16 | toner 16 | A(20.0) | A | B(1.6) | B(32) | C |
| Example 17 | toner 17 | A(20.0) | A | A(0.4) | A(43) | B |
| Example 18 | toner 18 | A(20.0) | A | A(0.3) | A(44) | A |
| Example 19 | toner 19 | A(20.0) | A | A(0.4) | A(43) | A |
| Example 20 | toner 20 | A(20.0) | A | B(1.6) | B(32) | A |
| Example 21 | toner 21 | A(20.0) | A | C(3.4) | C(24) | A |
| Example 22 | toner 22 | A(8.3) | C | B(1.6) | B(32) | A |
| Example 23 | toner 23 | A(12.5) | B | A(0.4) | A(41) | A |
| Example 24 | toner 24 | B(66.7) | A | A(0.2) | A(46) | A |
| Example 25 | toner 25 | C(125.0) | A | A(0.2) | A(46) | A |
| Example 26 | toner 26 | A(20.0) | B | A(0.3) | A(44) | A |
| Example 27 | toner 27 | A(20.0) | C | A(0.4) | A(41) | A |
| Example 28 | toner 28 | A(20.0) | A | C(4.2) | C(22) | B |
| Comparative | toner 29 | A(20.0) | A | D(6.4) | D(14) | D |
| example 1 | | | | | | |
| Comparative | toner 30 | D(166.7) | A | D(5.2) | D(19) | D |
| example 2 | | | | | | |
| Comparative | toner 31 | A(20.0) | A | D(5.6) | D(18) | A |
| example 3 | | | | | | |
| Comparative | toner 32 | A(20.0) | A | D(6.0) | D(15) | D |
| example 4 | | | | | | |
| Comparative | toner 33 | A(20.0) | A | D(6.1) | D(15) | B |
| example 5 | | | | | | |

While the present disclosure has been described with reference to examples and exemplary embodiments, it is to be understood that the disclosure is not so limited. The scope of the following claims is to be accorded the broadest interpretation so as to encompass all such modifications and equivalent structures and functions.

This application claims the benefit of Japanese Patent Application No. 2024-021721 filed Feb. 16, 2024, which is hereby incorporated by reference herein in its entirety.

What is claimed is:

1. A method for producing a toner comprising:
a washing step of washing resin particles with a washing liquid,
wherein the resin particles have the following functional group on a surface thereof,
—(COO⁻)ₙAⁿ⁺
wherein Aⁿ⁺ denotes a metal ion or an ammonium ion, and n denotes an integer of 1 or more and 3 or less,
the washing liquid contains fine bubbles,
the fine bubbles in the washing liquid have a number-average particle diameter of 1.0×10¹ nm or more and 1.0×10⁵ nm or less, and
the fine bubbles in the washing liquid have a zeta potential of −60 mV or more and 0 mV or less.

2. The method for producing a toner according to claim 1, wherein a surface of the resin particles has an acid value of 0.02 mgKOH/g or more and 1.00 mgKOH/g or less.

3. The method for producing a toner according to claim 1, wherein the fine bubbles in the washing liquid have a number concentration of 1.0×10⁴ particles/mL or more.

4. The method for producing a toner according to claim 1, wherein the fine bubbles in the washing liquid have a zeta potential of −30 mV or more and −10 mV or less.

5. The method for producing a toner according to claim 1, wherein the fine bubbles in the washing liquid have a number-average particle diameter of 1.0×10¹ nm or more and 1.0×10³ nm or less.

6. The method for producing a toner according to claim 1, wherein the resin particles in the washing step are washed by passing the washing liquid through a cake to be washed containing the resin particles.

7. The method for producing a toner according to claim 6, wherein the cake to be washed in the washing step is continuously washed while being transferred.

8. The method for producing a toner according to claim 1, wherein a ratio P/W of a mass P of the resin particles in the washing step to a mass W of the washing liquid used in the washing step is 0.1 or more and 1.0 or less.

9. The method for producing a toner according to claim 1, wherein a ratio M/W of a mass M of the metal ion or the ammonium ion in the resin particles in the washing step to a mass W of the washing liquid used in the washing step is 5.0×10⁻⁶ or less.

10. The method for producing a toner according to claim 1, wherein the resin particles have an average circularity of 0.960 or more.

11. The method for producing a toner according to claim 1, wherein a reduction ratio (M1−M2)/M1 of a mass of the metal ion or the ammonium ion is 0.50 or more, wherein M1 denotes the mass of the metal ion or the ammonium ion before the washing step, and M2 denotes the mass of the metal ion or the ammonium ion after the washing step.
